(19) United States
(12) Patent Application Publication
(10) Pub. No.: US 2023/0340290 A1
(43) Pub. Date: Oct. 26, 2023

(54) AQUEOUS POLYMER LATEX OF FILM-FORMING COPOLYMERS SUITABLE AS BINDER IN WATERBORNE COATING COMPOSITIONS

(71) Applicant: BASD SE, Ludwigshafen am Rhein (DE)

(72) Inventors: Konrad ROSCHMANN, Ludwigshafen am Rhein (DE); Bastiaan LOHMEIJER, Ludwigshafen am Rhein (DE); Thomas WOLF, Ludwigshafen am Rhein (DE); Immanuel WILLERICH, Ludwigshafen am Rhein (DE); Oliver WAGNER, Ludwigshafen am Rhein (DE); Sabine EICHHORN, Ludwigshafen am Rhein (DE); Christoph FLECKENSTEIN, Ludwigshafen am Rhein (DE); Friederike FLEISCHHAKER, Ludwigshafen am Rhein (DE); Andrea MISSKE, Ludwigshafen am Rhein (DE); Martin Robert SCHEUBLE, Ludwigshafen am Rhein (DE)

(21) Appl. No.: 18/016,968

(22) PCT Filed: Jul. 19, 2021
(86) PCT No.: PCT/EP2021/070108

§ 371 Date: Jan. 19, 2023

(30) Foreign Application Priority Data
Jul. 20, 2020 (EP) 20186698.5
Dec. 21, 2020 (EP) 20215915.8

(51) Int. Cl. C09D 133/12; C08K 3/22; C08F 220/14

(52) U.S. Cl. CPC C09D 133/12; C08K 3/22; C08F 220/14; C08K 2003/2241

(57) ABSTRACT

The present invention relates to aqueous polymer latexes of film-forming copolymers which are suitable as binders in waterborne coating compositions, and are obtainable by aqueous emulsion polymerisation of ethylenically unsaturated monomers M, which comprise •20 to 95% by weight, based on the total amount of monomers M, of at least one monomer M1, which is selected from isobutyl acrylate and isoamyl acrylate and mixtures thereof; •0 to 55% by weight, based on the total amount of monomers M, of at least one monomer M2, which is selected from ethyl acrylate, n-propyl acrylate, n-butyl acrylate, n-pentyl acrylate, C₆-C₂₀-alkyl esters of acrylic acid and C₅-C₂₀-alkyl esters of methacrylic acid and mixtures thereof; •5 to 50% by weight, based on the total amount of monomers M, of at least one monomer M3, which is selected from tert-butyl acrylate, C₁-C₄-alkyl esters of methacrylic acid, C₅-C₂₀-cycloalkyl esters of acrylic acid, C₅-C₂₀-cycloalkyl esters of methacrylic acid, C₅-C₂₀-cycloalkylmethyl esters of acrylic acid, C₅-C₂₀-cycloalkylmethyl esters of methacrylic acid, where cycloalkyl in the aforementioned monomers is mono-, bi- or tricyclic and where 1 or 2 CH₂ moieties of cycloalkyl may be replaced by O and where cycloalkyl may be unsubstituted or carry 1, 2, 3 or 4 methyl groups, and monovinyl aromatic monomers and mixtures thereof; •0.05 to 4% by weight, based on the total amount of monomers M, of least one monomer M4, which is selected from monoethylenically unsaturated monomers having an acidic group; where the total amount of monomers M1 and M2 is in the range from 45 to 95% by weight, in particular 50 to 90% by weight, especially 55 to 85% by weight based on the total amount of ethylenically unsaturated monomers M, and where the total amount of monomers M1, M2 and M3 is at least 90% by weight, in particular at least 95% by weight, based on the total amount of ethylenically unsaturated monomers M.

The present invention relates to aqueous polymer latexes of film-forming copolymers obtainable by aqueous emulsion polymerisation of ethylenically unsaturated monomers M, which comprise at least 90% by weight, based on the monomers M, of at least two different non-ionic monomers, which are selected from acrylate monomers, methacrylate monomers and monovinyl aromatic monomers. The present invention also relates to a process for producing such polymer latexes and to the use of these polymer latexes as binders in waterborne coating compositions, in particular latex paints, especially latex paints for architectural coatings, and wood coatings, such as wood paints and wood staining.

Polymer latexes, also referred to as polymer dispersions, are commonly known, in particular as a binder or binder component, also termed co-binder, for coating compositions. As a binder or co-binder in coating compositions, one of the important requirements is that they provide hardness and blocking resistance to the coatings.

Furthermore, the polymer latex should provide low water uptake, good weathering resistance, in particular against humidity and exposure to UV radiation, and good flexibility to the coating.

U.S. Pat. No. 4,267,091 describes binder compositions for paints and pebble dash renderings containing
A) a polymer latex made by emulsion polymerization of ethylenically unsaturated monomers which comprise alkyl (meth)acrylates as a main monomer component and a carbonyl group containing monomer such as formyl styrene and diacetone acrylamide,
B) a dihydrazine compound, and
C) a water soluble salt zinc salt.

WO 2011/009874 describes aqueous polymer dispersions based on ethylenically unsaturated monomers, which comprise 20 to 75% by weight of tert-butyl (meth)acrylate. The polymer latex provides improved flame retardance and thus is particularly suitable for producing architectural coatings, heat-insulation coatings and construction adhesives.

WO 2012/130712 describes polymer latexes prepared by two-stage emulsion polymerization and the use thereof as a binder in waterborne coating compositions for wood coating. The polymer dispersions show good storage stability and the coating compositions prepared therefrom result in coatings having good wet adhesion and good hardness.

WO 2014/07595 describes the use of polymer latexes comprising at least two different monomers, whose homopolymers have a theoretical glass transition temperature of at least 25° C. and at least two different monomers, whose homopolymers have a theoretical glass transition temperature of below 25° C. as a binder for improving the color retention of the exterior coating.

WO 2016/042116 describes polymer dispersions prepared by two-stage emulsion polymerization in the presence of a copolymerizable emulsifier and the use thereof as a binder in waterborne coating compositions for wood coating. The coating compositions prepared therefrom result in coatings having good water resistance and good hardness.

Despite the progress made in many respects, it remains a challenging task to provide polymer dispersions with a balanced application profile, as not only the application properties but also the stability of the polymer dispersion have to be considered. In particular, it is difficult to reconcile the different coating property requirements at the same time through the binder. As a rule, the attempt to improve one property of the coating through changes in the polymer composition of the binder leads to other properties of the coating deteriorating significantly.

While the polymer dispersions described in the above references have particular advantages in one or more aspects, they do not always have a well balanced application profile. Apart from that, they are solely based on monomers, which are prepared from fossil sources. In view of the ongoing discussion about the impact of CO₂ emission, there is a demand of reducing fossil carbon in the production of the polymer latexes.

It is therefore an object of the present invention to provide a polymer latex which has a well balanced application profile, which allows for using the polymer latex as a binder or co-binder in water-borne coating compositions, in particular in waterborne coating compositions for exterior application. Yet, the demand of fossil carbon should also be reduced.

It was surprisingly found that polymer latexes based on acrylate monomers, methacrylate monomers and/or monovinyl aromatic monomers which contain a certain quantity of monomers M1 selected from isobutyl acrylate and isoamyl acrylate and mixtures thereof improve the coating properties of coating compositions, in particular of coating compositions, namely whitening resistance, water-uptake and flexibility of the coating without deteriorating other properties such as blocking resistance and surface hardness. Moreover, the monomers M1 can be—at least with regard to their alkanol part—obtained from biological sources and thus allow for reducing the demand of fossil carbon in the production of the polymer latexes.

The present invention therefore relates to aqueous polymer latexes of film-forming copolymers obtainable by aqueous emulsion polymerisation of ethylenically unsaturated monomers M, which comprise
20 to 90% by weight, in particular 25 to 90% by weight, especially 30 to 85% by weight, based on the total amount of monomers M, of at least one monomer M1, which is selected from isobutyl acrylate, 2-methylbutyl acrylate and isoamyl acrylate and mixtures thereof;
0 to 55% by weight, e.g. 5 to 55% by weight, in particular 0 to 50% by weight or 5 to 50% by weight, especially 0 to 40% by weight or 5 to 40% by weight, based on the total amount of monomers M, of at least one monomer M2, which is selected from ethyl acrylate, n-propyl acrylate, n-butyl acrylate, n-pentyl acrylate, C₆-C₂₀-alkyl esters of acrylic acid and C₅-C₂₀-alkyl esters of methacrylic acid and mixtures thereof;
5 to 50% by weight, in particular 10 to 45% by weight, especially 15 to 45% by weight, based on the total amount of monomers M, of at least one monomer M3, which is selected from tert-butyl acrylate, C₁-C₄-alkyl esters of methacrylic acid, C₅-C₂₀-cycloalkyl esters of acrylic acid, C₅-C₂₀-cycloalkyl esters of methacrylic acid, C₅-C₂₀-cycloalkylmethyl esters of acrylic acid, C₅-C₂₀-cycloalkylmethyl esters of methacrylic acid, where cycloalkyl in the aforementioned monomers is mono-, bi- or tricyclic and where 1 or 2 CH₂ moieties of cycloalkyl may be replaced by O and where cycloalkyl may be unsubstituted or carry 1, 2, 3 or 4 methyl groups, and monovinyl aromatic monomers and mixtures thereof;
0.05 to 4% by weight, preferably from 0.05 to 3.5% by weight, in particular from 0.1 to 4% by weight or from 0.1 to 3% by weight, especially from 0.2 to 3% by weight or from 0.5 to 3% by weight or from 0.5 to 2% by weight, based on the total weight of the monomers M, of least one monomer M4, which is selected from monoethylenically unsaturated monomers having an acidic group,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 92% by weight, especially at least 95% by weight, based on the total amount of ethylenically unsaturated monomers M.

The present invention also relates to a process for producing the aqueous polymer latexes of the present invention. The process comprises performing an aqueous emulsion polymerisation of the monomers M.

The present invention also relates to the use of these polymer latexes as binders or co-binders in waterborne coating compositions, in particular in waterborne compositions for wood coating, such as waterborne wood stain formulations, waterborne wood paint formulations and waterborne clearcoat formulations for wooden surfaces, but also for waterborne architectural coatings. The present invention also relates to the use of the aqueous polymer latexes described herein for improving the resistance of coatings obtained from waterborne coating composition as described herein to water or humidity.

Furthermore, the present invention relates to waterborne coating compositions which contain
a) a binder polymer in the form of the aqueous polymer latex as defined herein; and
b) at least one further ingredient, which is conventionally used in waterborne coating compositions and which is not a binder.

The present invention is associated with several benefits.
The polymer latexes are stable and provide a good and well balanced application profile to waterborne coating compositions.
Since the polymer latexes contain considerable amounts of monomers M1, which can be obtained from biological sources, they allow for a significant reduction in the need of fossil carbon, in particular by at least 10%, especially at least 15% or even at least 20%.
Waterborne coating compositions containing a polymer latex of the invention as a binder or co-binder have improved flexibility.
Waterborne coating compositions containing a polymer latex of the invention as a binder or co-binder show a very good blocking resistance.
Waterborne coating compositions containing a polymer latex of the invention as a binder or co-binder have good weathering resistance, in particular against moisture and UV radiation, in particular improved whitening resistance.
Waterborne coating compositions containing a polymer latex of the invention show improved scrub resistance, improved gloss and improved thickening efficiency at high and low shear rates, reduced dirt pick-up as well as comparable opacity, adhesion and stain resistance.
Due to their well balanced application profile, the polymer latexes are particularly useful as binders or co-binders in waterborne wood coatings, and have beneficial properties both in waterborne primers and in water-borne top coat formulations.

Here and throughout the specification, the term “(meth)acryl” includes both acryl and methacryl groups. Hence, the term “(meth)acrylate” includes acrylate and methacrylate and the term “(meth)acrylamide” includes acrylamide and methacrylamide.

Here and throughout the specification, the term “waterborne coating composition” means a liquid aqueous coating composition containing water as the continuous phase in an amount sufficient to achieve flowability.

Here and throughout the specification, the terms “wt.-%” and “% by weight (% b.w.)” are used synonymously.

Here and throughout the specification, the term “pphm” means parts by weight per 100 parts of monomers and corresponds to the relative amount in % by weight of a certain substance based on the total amount of monomers M.

Here and throughout the specification, the term “ethylenically unsaturated monomer” is understood that the monomer has at least one C═C double bond, e.g. 1, 2, 3 or 4 C═C double bonds, which are radically polymerizable, i.e. which under the conditions of an aqueous radical emulsion polymerization process are polymerized to obtain a polymer having a backbone of carbon atoms. Here and throughout the specification, the term “monoethylenically unsaturated” is understood that the monomer has a single C═C double bond, which is susceptible to radical polymerization under conditions of an aqueous radical emulsion polymerization.

Here and throughout the specification, the terms “ethoxylated” and “polyethoxylated” are used synonymously and refer to compounds having an oligo- or polyoxyethylene group, which is formed by repeating units O—CH₂CH₂. In this context, the term “degree of ethoxylation” relates to the number average of repeating units O—CH₂CH₂ in these compounds.

Here and throughout the specification, the term “non-ionic” in the context of compounds, especially monomers, means that the respective compound does not bear any ionic functional group or any functional group, which can be converted by protonation or deprotonation into an ionic group.

Here and throughout the specification, the prefixes Cₙ-Cₘ used in connection with compounds or molecular moieties each indicate a range for the number of possible carbon atoms that a molecular moiety or a compound can have. The term “C₁-Cₙ alkyl” denominates a group of linear or branched saturated hydrocarbon radicals having from 1 to n carbon atoms. The term “Cₙ/Cₘ alkyl” denominates a mixture of two alkyl groups, one having n carbon atoms while the other having m carbon atoms.

For example, the term C₁-C₂₀ alkyl denominates a group of linear or branched saturated hydrocarbon radicals having from 1 to 20 carbon atoms, while the term C₁-C₄ alkyl denominates a group of linear or branched saturated hydrocarbon radicals having from 1 to 4 carbon atoms and the C₅-C₂₀ alkyl denominates a group of linear or branched saturated hydrocarbon radicals having from 5 to 20 carbon atoms. Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl their isomers, in particular mixtures of isomers such as “isononyl”, “isodecyl”. Examples of C₁-C₄-alkyl are for example methyl, ethyl, propyl, 1-methylethyl, butyl, 1-methylpropyl, 2-methylpropyl or 1,1-dimethylethyl.

The term “C₅-C₂₀-cycloalkyl” as used herein refers to an mono- or bicyclic cycloaliphatic radical which is unsubstituted or substituted by 1, 2, 3 or 4 methyl radicals, where the total number of carbon atoms of C₅-C₂₀-cycloalkyl from 5 to 20. Examples of C₅-C₂₀-cycloalkyl include but are not limited to cyclopentyl, cyclohexyl, methylcyclohexyl, dimethylcyclohexyl, cycloheptyl, cyclooctyl, cyclododecyl, cyclohexadecyl, norbornyl (=bicyclo[2.2.1]heptyl) and isobornyl (=1,7,7-trimethylbicyclo[2.2.1]heptyl). In cycloalkyl, 1 or 2 of the CH₂ groups may be replaced by non-adjacent oxygen ring atoms, resulting in heterocycloaliphatic radicals. Examples of such radicals include, but are not limited to oxolan-2-yl, oxolan-3-yl, oxan-2-yl, oxan-3-yl, oxan-4-yl, 1,3-dioxolan-2-yl, 1,3-dioxolan-4-yl, 2,2-dimethyl-1,3-dioxolan-4-yl, 1,4-dioxan-2-yl, 1,3-dioxan-2-yl, 1,3-dioxan-4-yl, 1,3-dioxan-5-yl, 2,2-dimethyl-1,3-dioxan-4-yl, 2,2-dimethyl-1,3-dioxan-5-yl.

The term “C₅-C₂₀-cycloalkylmethyl” as used herein refers to a C₅-C₂₀-cycloalkyl radical as defined herein, which is bound via a methylene group.

According to the invention, the monomers M comprise at least one monomer M1 selected from isobutyl acrylate, 2-methylbutyl acrylate and isoamyl acrylate and mixtures thereof. Isoamyl acrylate is also referred to as isopentyl acrylate or 3-methylbutyl acrylate, respectively. 2-Methylbutyl acrylate is a chiral compound and thus may exist in racemic form or in the form of non-racemic mixtures, comprising one of its enantiomers excess. According to the invention, the monomer M1 includes both non-racemic 2-methylbutyl acrylate and racemic 2-methylbutyl acrylate.

In particular groups of embodiments, the monomers M1 comprise at least 50% by weight, in particular at least 80% by weight, especially at least 90% by weight of isobutyl acrylate, based on the total amount of monomers M1. Especially, the monomer M1 is isobutyl acrylate.

In other particular groups of embodiments, the monomers M1 comprise at least 50% by weight, in particular at least 80% by weight, especially at least 90% by weight of isoamyl acrylate, based on the total amount of monomers M1. In this particular group of embodiment, the monomer M1 is especially isoamyl acrylate.

In yet other particular groups of embodiments, the monomers M1 comprise at least 50% by weight, in particular at least 80% by weight of 2-methylbutyl acrylate, based on the total amount of monomers M1. In this particular group of embodiment, the monomer M1 is especially 2-methylbutyl acrylate.

In yet other particular groups of embodiments, the monomers M1 is a mixture comprising isoamyl acrylate and 2-methylbutyl acrylate in an amount of at least 50% by weight, in particular at least 80%, based on the total amount of monomers M1 and optionally up to 50% by weight especially not more than 20% by weight, based on the total amount of monomers M1, of isobutyl acrylate. In this particular group of embodiment, the monomer molar ratio of 3-methylbutyl acrylate to 2-methylbutyl acrylate is in particular in the range of 1:1 to 10:1.

Isobutyl acrylate, 2-methylbutyl acrylate and isopentyl acrylate are typically produced by esterification of acrylic acid with isobutanol (2-methylpropan-1-ol), 2-methylbutanol or isopentanol (3-methylbutan-1-ol), respectively, or by transesterification of methyl acrylate or ethyl acrylate with isobutanol (2-methylpropan-1-ol), 2-methylbutan-1-ol or isopentanol (3-methylbutan-1-ol), respectively.

Both isobutanol, 2-methylbutanol and isopentanol, as well as mixtures thereof, can be produced on large scale by fermentation from a variety of renewable feedstocks, including corn, wheat, sorghum, barley, and sugar cane, in particular from cellulose containing raw material and thus from biological sources or renewable raw materials, respectively. Therefore, including monomers M1 into the polymer latex significantly increases the amount of bio-carbon in the polymer latex and thereby reduces the demand of fossil carbon and, hence, the CO₂ demand of the production of the polymer latex. In particular, fermentation may produce a mixture comprising different alkanols from which isobutanol, 2-methylbutan-1-ol and 3-methylbutan-1-ol can be separated by conventional techniques such as fractionated distillation. Thereby either the pure alcohols (purity >90%) may be obtained or mixtures containing at least two alcohols selected from the group consisting of isobutanol, 2-methylbutan-1-ol and 3-methylbutan-1-ol in a total amount of at least 80%, in particular at least 90% can be obtained. For example, a mixture comprising at least 80% by weight of a mixture of 2-methyl butanol and 3-methyl butanol and up to 20% by weight of isobutanol may be used for esterification or trans-esterification. In this mixture the molar ratio of 3-methylbutanol to 2-methylbutan-1-ol may vary, e.g. from 1:10 to 10:1 and is in particular in the range of 1:1 to 10:1.

The acrylic acid used for esterification may be obtained from fossil sources according to standard procedures. Acrylic acid may also be prepared from renewable raw materials, e.g. according to WO 2006/092272 or DE 10 2006 039 203 A or EP 2 922 580.

It is also possible that at least part of the educts used to synthesize bio-based monomers M1 from renewable raw materials according to the mass balance approach. Accordingly, in addition to fossil feeds, also renewable feeds such as bio-naphtha (as e.g. described in EP 2 290 045 A1 or EP 2 290 034 A1) enter the chemical production system, such as a steam cracker. The renewable feeds are converted into products along the chemical value chain, such as acrylic acid, isobutanol, isoamyl alcohol or 2-methylbutanol, or isobutyl acrylate, isoamyl acrylate or 2-methylbutyl acrylate. The content of renewable material of these products is defined by the mass balance approach and can be allocated to these products.

Therefore, a particular embodiment of the invention relates to a polymer latex as defined herein, wherein the at least the carbon atoms of the isobutyl group, the 2-methylbutyl group and the isoamyl group in the monomers M1 are of biological origin, i.e. e. they are at least partly made of bio-carbon. In particular, the isobutanol, the 2-methylbutan-1-ol and the isopentanol used for the production of the monomers M1 preferably have a content of bio-carbon of at least 90 mol-%, based on the total amount of carbon atoms in isobutanol, 2-methylpentanol and isopentanol, respectively. This content is advantageously higher, in particular greater than or equal to 95 mol-%, preferably greater than or equal to 98 mol-% and advantageously equal to 100 mol-%. Similarly, acrylic acid may be produced from renewable materials. However, acrylic acid produced from biomaterials is not available on large scale so far. Consequently, the monomers M1 have a content of bio-carbon of preferably at least 51 mol-%, in particular at least 54 mol-% and especially at least 57 mol-%, based on the total amount of carbon atoms in isobutyl acrylate, 2-methylbutyl acrylate and isopentyl acrylate, respectively. By using monomers M1, which are at least partly of biological origin, the demand of fossil carbon in the polymer latex can be significantly reduced. In particular, the amount of carbon of biological origin of at least 10 mol-%, in particular at least 15 mol-% or at least 20 mol-% or higher, e.g. 30 mol-% or 40 mol-% or higher can be achieved.

The term “bio-carbon” indicates that the carbon is of biological origin and comes from a biomaterial/renewable resources. The content in bio-carbon and the content in biomaterial are expressions that indicate the same value. A material of renewable origin or biomaterial is an organic material wherein the carbon comes from the CO₂ fixed recently (on a human scale) by photosynthesis from the atmosphere. A biomaterial (Carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of bio-carbon is can be carried out in accordance with the standards ASTM D 6866-12, the method B (ASTM D 6866-06) and ASTM D 7026 (ASTM D 7026-04).

In addition to the monomers M1, the monomers M forming the polymer of the latex may comprise one or more monomers M2 as defined above.

Suitable monomers M2 are selected from the group consisting of:
n-ethyl acrylate, n-propyl acrylate, n-butyl acrylate, n-pentyl acrylate;
C₅-C₂₀-alkyl esters of acrylic acid, including but are not limited to n-hexyl acrylate, n-octyl acrylate, 2-ethylhexyl acrylate, n-decyl acrylate, isodecyl acrylate, 2-propylheptyl acrylate, lauryl acrylate, C₁₂/C₁₄-alkyl acrylate, C₁₂-C₁₅-alkyl acrylate, isotridecyl acrylate, C₁₆/C₁₈-alkyl acrylate and stearyl acrylate;
C₅-C₂₀-alkyl esters of methacrylic acid, including but are not limited to n-pentyl methacrylate, n-hexyl methacrylate, n-octyl methacrylate, 2-ethylhexyl methacrylate, n-decyl methacrylate, 2-propylheptyl methacrylate, lauryl methacrylate, C₁₂/C₁₄-alkyl methacrylate, C₁₂-C₁₅-alkyl methacrylate, isotridecyl methacrylate, C₁₆/C₁₈-alkyl methacrylate and stearyl methacrylate;
and mixtures thereof.

Preferred monomers M2 are selected from the group consisting of n-ethyl acrylate, n-butyl acrylate, n-pentyl acrylate, n-hexyl acrylate, n-octyl acrylate, 2-ethylhexyl acrylate, 2-propylheptyl acrylate and mixtures thereof, such as for example mixtures of n-butyl acrylate and 2-ethylhexylacrylate or mixtures of n-butyl acrylate and ethyl acrylate or mixtures of ethyl acrylate, n-butyl acrylate and 2-ethylhexyl acrylate and mixtures thereof.

More preferred monomers M2 are selected from the group consisting of n-butyl acrylate and 2-ethylhexyl acrylate and mixtures thereof.

Suitable monomers M3 are selected from the group consisting of:
C₁-C₄-alkyl esters of methacrylic acid, such as methyl methacrylate, ethyl methacrylate, n-propyl methacrylate, isopropyl methacrylate, n-butyl methacrylate, sec-butyl methacrylate, isobutyl methacrylate and tert-butyl methacrylate;
tert-butyl acrylate;
C₅-C₂₀-cycloalkyl esters of (meth)acrylic acid including but are not limited to cyclohexylacrylate, cyclohexylmethacrylate, norbornylacrylate, norbornylmethacrylate, isobornylacrylate, isobornylmethacrylate, 1,3-dioxan-5-yl-acrylate, 1,3-dioxan-5-yl-methacrylate, 2,2-dimethyl-1,3-dioxan-5-yl-acrylate, 2,2-dimethyl-1,3-dioxan-5-yl-methacrylate;
C₅-C₂₀-cycloalkylmethyl esters of (meth)acrylic acid including but are not limited to cyclohexylmethylacrylate, cyclohexylmethylmethacrylate, 1,3-dioxolan-4-yl-methyl acrylate, 1,3-dioxolan-4-ylmethyl methacrylate, 2,2-dimethyl-1,3-dioxolan-4-ylmethyl acrylate, 2,2-dimethyl-1,3-dioxolan-4-ylmethyl methacrylate, oxolan-2-yl-methyl acrylate (tetrahydrofurfuryl acrylate) and oxolan-2-yl-methyl methacrylate (tetrahydrofurfuryl methacrylate);
monovinyl aromatic monomers, such as styrene, 2-methylstyrene, 4-methylstyrene;
and mixtures thereof.

Preferred monomers M3 are selected from the group consisting of:
C₁-C₄-alkyl esters of methacrylic acid, in particular methyl methacrylate, ethyl methacrylate, n-butyl methacrylate, isobutyl methacrylate and tert-butyl methacrylate;
tert-butyl acrylate;
cyclohexylmethacrylate, isobornylacrylate, isobornylmethacrylate;
styrene;
and mixtures thereof.

Particularly referred monomers M3 are selected from the group consisting of:
methyl methacrylate, n-butyl methacrylate;
tert-butyl acrylate;
cyclohexylmethacrylate, isobornylmethacrylate;
styrene;
and mixtures thereof.

In particular, the monomers M3 comprise methyl methacrylate in an amount of at least 50% by weight, in particular at least 80% by weight or 100% by weight, based on the total amount of monomers M3 in the monomers M. More particularly, the monomer M3 is selected from the group consisting of methyl methacrylate and combinations of methyl methacrylate with n-butyl methacrylate, tert-butyl acrylate cyclohexylmethacrylate, isobornylmethacrylate or with styrene.

Suitable monomers M4 include, but are not limited to
monoethylenically unsaturated monocarboxylic acids having 3 to 6 carbon atoms, such as acrylic acid, methacrylic acid, crotonic acid, 2-ethylpropenoic acid, 2-propylpropenoic acid, 2-acryloxyacetic acid and 2-methacryloxyacetic acid;
monoethylenically unsaturated dicarboxylic acids having 4 to 6 carbon atoms, such as itaconic acid, citraconic acid and fumaric acid;
semi-esters of monoethylenically unsaturated dicarboxylic acids having 4 to 6 carbon atoms, with C₁-C₄ alkanols, such as methanol or ethanol, such as semi-esters of itaconic acid, citraconic acid, maleic acid or fumaric acid with methanol or ethanol;
monoethylenically unsaturated sulfonic acids, such as vinylsulfonic acid, allylsulfonic acid, styrenesulfonic acid, 2-acrylamido-2-methylpropane sulfonic acid,
monoethylenically unsaturated phosphonic acids such as vinylphosphonic acid, allylphosphonic acid, styrenephosphonic acid and 2-acrylamido-2-methylpropane phosphonic acid,
monoethylenically unsaturated phosphoric acids such as monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, in particular monophosphates of hydroxyethyl acrylate, hydroxypropyl acrylate or hydroxybutyl acrylate, monophosphates of hydroxyethyl methacrylate, hydroxypropyl methacrylate or hydroxybutyl methacrylate, monophosphates of ethoxylated hydroxy-C₂-C₄-alkyl acrylates, monophosphates of propoxylated hydroxy-C₂-C₄-alkyl acrylates, monophosphates of ethoxylated hydroxy-C₂-C₄-alkyl methacrylates and monophosphates of propoxylated hydroxy-C₂-C₄-alkyl methacrylates.

The aforementioned monomers M4 can be present in their acidic form or in the form of their salts, in particular in the form of their alkalimetal salts or ammonium salts.

Amongst the aforementioned monomers M4, preference is given to monoethylenically unsaturated monocarboxylic acids and monoethylenically unsaturated dicarboxylic acids. Particular preference is given to acrylic acid, methacrylic acid, itaconic acid and mixtures thereof. More preference is given to monoethylenically unsaturated monocarboxylic acids, in particular to acrylic acid, methacrylic acid and mixtures thereof. In a particular group of embodiments, the monomer M4 comprises methacrylic acid. Especially, the monomer M4 is methacrylic acid or a mixture of acrylic acid and methacrylic acid.

The total amount of monomers M4 is from 0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M.

Preferably, the monomers M comprise:
20 to 90% by weight, in particular 25 to 90% by weight, especially 30 to 85% by weight, based on the total amount of monomers M, of monomers M1 having at least 50 mol-% of bio-carbon;
0 to 55% by weight, in particular 0 to 50% by weight, especially 0 to 40% by weight, based on the total amount of monomers M, of at least one monomer M2, which is selected from n-ethyl acrylate, n-butyl acrylate, n-pentyl acrylate, n-hexyl acrylate, n-octyl acrylate, 2-ethylhexyl acrylate, 2-propylheptyl acrylate and mixtures thereof, such as for example mixtures of n-butyl acrylate and 2-ethylhexylacrylate or mixtures of n-butyl acrylate and ethyl acrylate or mixtures of ethyl acrylate, n-butyl acrylate and 2-ethylhexyl acrylate and mixtures thereof;
5 to 50% by weight, in particular 10 to 45% by weight, especially 15 to 45% by weight, based on the total amount of monomers M, of at least one monomer M3, which is selected from tert-butyl acrylate, methyl methacrylate, ethyl methacrylate, n-butyl methacrylate, isobutyl methacrylate, tert-butyl methacrylate, cyclohexylmethacrylate, isobornylacrylate, isobornylmethacrylate and styrene and mixtures thereof;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from monoethylenically unsaturated monocarboxylic acids and monoethylenically unsaturated dicarboxylic acids and mixtures thereof,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 92% by weight, especially at least 95% by weight, based on the total amount of ethylenically unsaturated monomers M.

In particular, the monomers M comprise:
20 to 90% by weight, in particular 25 to 90% by weight, especially 30 to 85% by weight, based on the total amount of monomers M, of monomers M1 having at least 50 mol-% of bio-carbon;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of at least one monomer M3, which is selected from tert-butyl acrylate, methyl methacrylate, n-butyl methacrylate, cyclohexylmethacrylate, isobornylmethacrylate and styrene and mixtures thereof;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from monoethylenically unsaturated monocarboxylic acids,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M.

Even more preferably, the monomers M comprise:
20 to 90% by weight, in particular 25 to 90% by weight, especially 30 to 85% by weight, based on the total amount of monomers M, of monomers M1 having at least 50 mol-% of bio-carbon;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of the monomer M3, which is selected from methyl methacrylate and combinations of methyl methacrylate and at least one further monomer M3, selected from tert-butyl acrylate, n-butyl methacylate, cyclohexylmethacrylate, isobornylmethacrylate and styrene;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from acrylic acid, methacrylic acid, itaconic acid and mixtures thereof,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M.

Especially, the monomers M comprise:
20 to 90% by weight, in particular 25 to 90% by weight, especially 30 to 85% by weight, based on the total amount of monomers M, of monomers M1 having at least 50 mol-% of bio-carbon;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of methyl methacrylate as a monomer M3;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from methacrylic acid and mixtures of acrylic acid with methacrylic acid,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M.

In a particular group 1 of embodiments, the monomers M comprise:
20 to 90% by weight, in particular 25 to 90% by weight, especially 30 to 85% by weight, based on the total amount of monomers M, of isobutyl acrylate in particular of isobutyl acrylate having at least 50 mol-% of bio-carbon as a monomer M1;
0 to 55% by weight, in particular 0 to 50% by weight, especially 0 to 40% by weight, based on the total amount of monomers M, of at least one monomer M2, which is selected from n-ethyl acrylate, n-butyl acrylate, n-pentyl acrylate, n-hexyl acrylate, n-octyl acrylate, 2-ethylhexyl acrylate, 2-propylheptyl acrylate and mixtures thereof, such as for example mixtures of n-butyl acrylate and 2-ethylhexylacrylate or mixtures of n-butyl acrylate and ethyl acrylate or mixtures of ethyl acrylate, n-butyl acrylate and 2-ethylhexyl acrylate and mixtures thereof;
5 to 50% by weight, in particular 10 to 45% by weight, especially 15 to 45% by weight, based on the total amount of monomers M, of at least one monomer M3, which is selected from tert-butyl acrylate, methyl methacrylate, ethyl methacrylate, n-butyl methacrylate, isobutyl methacrylate, tert-butyl methacrylate, cyclohexylmethacrylate, isobornylacrylate, isobornylmethacrylate and styrene and mixtures thereof;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from monoethylenically unsaturated monocarboxylic acids and monoethylenically unsaturated dicarboxylic acids and mixtures thereof,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 92% by weight, especially at least 95% by weight, based on the total amount of ethylenically unsaturated monomers M.

In the particular group 1 of embodiments, the monomers M preferably comprise:
20 to 90% by weight, in particular 25 to 90% by weight, especially 30 to 85% by weight, based on the total amount of monomers M, of isobutyl acrylate in particular of isobutyl acrylate having at least 50 mol-% of bio-carbon as a monomer M1;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of at least one monomer M3, which is selected from tert-butyl acrylate, methyl methacrylate, n-butyl methacrylate, cyclohexylmethacrylate, isobornylmethacrylate and styrene and mixtures thereof;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from monoethylenically unsaturated monocarboxylic acids,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M (group 1a of embodiments).

In the particular group 1 of embodiments, the monomers M more preferably comprise:
20 to 90% by weight, in particular 25 to 90% by weight, especially 30 to 85% by weight, based on the total amount of monomers M, of isobutyl acrylate in particular of isobutyl acrylate having at least 50 mol-% of bio-carbon as a monomer M1;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of the monomer M3, which is selected from methyl methacrylate and combinations of methyl methacrylate and at least one further monomer M3, selected from tert-butyl acrylate, n-butyl methacylate, cyclohexylmethacrylate, isobornylmethacrylate and styrene;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from acrylic acid, methacrylic acid, itaconic acid and mixtures thereof,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M (group 1 b of embodiments).

In the particular group 1 of embodiments, the monomers M especially comprise:
20 to 90% by weight, in particular 25 to 90% by weight, especially 30 to 85% by weight, based on the total amount of monomers M, of isobutyl acrylate in particular of isobutyl acrylate having at least 50 mol-% of bio-carbon as a monomer M1;
0 to 55% by weight, in particular 0 to 50% by weight, especially 0 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
5 to 50% by weight, in particular 10 to 45% by weight, especially 15 to 45% by weight, based on the total amount of monomers M, of methyl methacrylate as a monomer M3;
0.05 to 4% by weight or from 0.1 to 4% by weight, preferably from 0.05 to 3.5% by weight, in particular from 0.1 to 3% by weight, especially from 0.2 to 3% by weight or from 0.5 to 3% by weight or from 0.5 to 2% by weight, based on the total weight of the monomers M, of least one monomer M4, which is selected from methacrylic acid and mixtures of acrylic acid with methacrylic acid,
where the total amount of monomers M1 and M2 is in the range from 45 to 94.95% by weight or 45 to 94.9% by weight or 45 to 94.8% by weight or 45 to 94.5% by weight, in particular 50 to 89.95% by weight or 50 to 94.9% by weight or 50 to 94.8% by weight or 50 to 94.5% by weight, especially 55 to 84.95% by weight or 55 to 94.9% by weight or 55 to 94.8% by weight or 55 to 94.5% by weight, based on the total amount of ethylenically unsaturated monomers M, and where the total amount of monomers M1, M2 and M3 is at least 90% by weight, in particular at least 95% by weight, based on the total amount of ethylenically unsaturated monomers M (group 1c of embodiments).

In a particular group 2 of embodiments the type and amounts of monomers M1, M2, M3 and M4 are as defined the particular group 1 of embodiment, except that monomer M1 is isoamyl acrylate instead of isobutyl acrylate.

Amongst the particular group 2 of embodiments, preference is given to the embodiment 2a, where the type and amounts of monomers M1, M2, M3 and M4 are as defined the particular group 1a of embodiments, except that monomer M1 is isoamyl acrylate instead of isobutyl acrylate.

Amongst the particular group 2 of embodiments, particular preference is given to the embodiment 2b, where the type and amounts of monomers M1, M2, M3 and M4 are as defined the more preferred group 1b of embodiments, except that monomer M1 is isoamyl acrylate instead of isobutyl acrylate.

Amongst the particular group 2 of embodiments, special preference is given to the embodiment 2c, where the type and amounts of monomers M1, M2, M3 and M4 are as defined the special group 1c of embodiments, except that monomer M1 is isoamyl acrylate instead of isobutyl acrylate.

In a particular group 3 of embodiments the type and amounts of monomers M1, M2, M3 and M4 are as defined the particular group 1 of embodiment, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 3 of embodiments, preference is given to the embodiment 3a, where the type and amounts of monomers M1, M2, M3 and M4 are as defined the particular group 1a of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 3 of embodiments, particular preference is given to the embodiment 3b, where the type and amounts of monomers M1, M2, M3 and M4 are as defined the more preferred group 1 b of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 3 of embodiments, special preference is given to the embodiment 3c, where the type and amounts of monomers M1, M2, M3 and M4 are as defined the special group 1c of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

In addition to the aforementioned monomers M1, M2, M3 and M4, the monomers M may comprise one or more further monomers, which are different from the aforementioned monomers M. Suitable monomers M which are different from the monomers M1, M2, M3 and M4 include, but are not limited to
monomers M5, which are selected from monoethylenically unsaturated non-ionic monomers having a solubility in deionized water at 20° C. and 1 bar of at least 60 g/L;
monomers M6, which are selected from monoethylenically unsaturated non-ionic monomers having a silan functional group or an epoxy group;
monomers M7, which are selected from multiethylenically unsaturated monomers, i.e. monomers having at least two non-conjugated ethylenically unsaturated double bounds;
monomers M8, which are selected from monoethylenically unsaturated copolymerizable UV-initiators.

Suitable nonionic monoethylenically unsaturated monomer M5 are e.g. those which have a functional group selected from hydroxyalkyl groups, in particular hydroxy-C₂-C₄-alkyl group, a primary carboxamide group, urea groups and keto groups.

The total amount of monomers M5 will usually not exceed 10% by weight, in particular 7% by weight, based on the total amount of monomers M. In particular, the total amount of monomers M5, if present, is generally from 0.05 to 10% by weight, in particular 0.1 to 7% by weight, especially from 0.1 to 5% by weight or 0.1 to 4% by weight or 0.5 to 3% by weight or 1 to 3% by weight, based on the total weight of the monomers M.

Examples for monomers M5 having a carboxamide group (hereinafter monomers M5a) include, but are not limited to primary amides of monoethylenically unsaturated monocarboxylic acids having 3 to 6 carbon atoms, such as acrylamide and methacrylamide, and C₁-C₄-alkylamides of monoethylenically unsaturated monocarboxylic acids having 3 to 6 carbon atoms, such as N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide. Most preferably, monomer M5a is selected from acrylamide and methacrylamide.

Examples for monomers M5 having a urea group (hereinafter monomers M5b) are the C₁-C₄-alkyl esters of acrylic acid or methacrylic acid and the N—C₁-C₄-alkyl amides of acrylic acid or methacrylic acid, where the C₁-C₄-alkyl group bears an urea group or a 2-oxoimidazolin group such as 2-(2-oxo-imidazolidin-1-yl)ethyl acrylate, 2-(2-oxo-imidazolidin-1-yl)ethyl methacrylate, which are also termed 2-ureido acrylate and 2-ureido methacrylate, respectively, N-(2-acryloxyethyl)urea, N-(2-methacryloxyethyl)urea, N-(2-(2-oxo-imidazolidin-1-yl)ethyl) acrylamide, N-(2-(2-oxo-imidazolidin-1-yl)ethyl) methacrylamide, as well as allyl or vinyl substituted ureas and allyl or vinyl substituted 2-oxoimidazolin compounds such as 1-allyl-2-oxoimidazolin, N-allyl urea and N-vinylurea.

Examples for monomers M5 having a keto group (hereinafter monomers M5c) are the
C₂-C₈-oxoalkyl esters of acrylic acid or methacrylic acid and the N—C₂-C₈-oxoalkyl amides of acrylic acid or methacrylic acid, such as diacetoneacrylamide (DAAM), and diacetonemethacrylamide, and
C₁-C₄-alkyl esters of acrylic acid or methacrylic acid and the N—C₁-C₄-alkyl amides of acrylic acid or methacrylic acid, where the C₁-C₄-alkyl group bears a 2-acetylacetoxy group of the formula O—C(═O)—CH₂—C(═O)—CH₃ (also termed acetoacetoxy group), such as acetoacetoxyethyl acrylate, acetoacetoxypropyl methacrylate, acetoacetoxybutyl methacrylate and 2-(acetoacetoxy)ethyl methacrylate.

Suitable monomers M6 include monoethylenically unsaturated silan functional monomers (monomers M6a), e.g. monomers which in addition to an ethylenically unsaturated double bond bear at least one mono-, di- and/or tri-C₁-C₄-alkoxysilane group, such as vinyl trimethoxysilane, vinyl triethoxysilane, methacryloxyethyl trimethoxysilane, methacryloxyethyl triethoxysilane, and mixtures thereof. The amount of silan functional monomers M6a, if present, will usually not exceed 1 pphm, and frequently be in the range from 0.01 to 1 pphm.

Suitable monomers M6 also include monoethylenically unsaturated monomers bearing at least one epoxy group (monomers M6b), in particular a glycidyl group such as glycidyl acrylate, glycidyl methacrylate, 2-glycidyloxyethyl acrylate and 2-glycidyloxyethyl methacrylate. The amount of monomers M6b, if present will usually not exceed 2 pphm, and frequently be in the range from 0.01 to 2 pphm.

The monomers M may also include multiethylenically unsaturated monomers (monomers M7), i.e. monomers having at least two non-conjugated ethylenically unsaturated double bounds. The amounts of said monomers M7 will generally not exceed 1 pphm.

Examples of multiethylenically unsaturated monomers M7 include:
diesters of monoethylenically unsaturated C₃-C₆ monocarboxylic acids with saturated aliphatic or cycloaliphatic diols, in particular diesters of acrylic acid or methacrylic acid, such as the diacrylates and the dimethacrylates of ethylene glycol (1,2-ethanediol), propylene glycol (1,2-propanediol), 1,2-butanediol, 1,3-butanediol, 1,4-butanediol, neopentyl glycol (2,2-dimethyl-1,3-propanediol), 1,6-hexanediol and 1,2-cyclohexanediol;
monoesters of monoethylenically unsaturated C₃-C₆ monocarboxylic acids with monoethylenically unsaturated aliphatic or cycloaliphatic monohydroxy compounds, such as the acrylates and the methacrylates of vinyl alcohol (ethenol), allyl alcohol (2-propen-1-ol), 2-cyclohexen-1-ol or norbornenol, such as allyl acrylate and allyl methacrylate; and
divinyl aromatic compounds, such as 1,3-divinyl benzene, 1,4-divinyl benzene.

Polymerized monoethylenically unsaturated copolymerizable UV-initiators M8 result in a crosslinking of the polymer chain upon exposure to sunlight. Monomers M8 bear an ethylenically unsaturated double bond, in particular an acrylate or methacrylate group and a moiety that is decomposed by UV radiation whereby a radical is formed. Such groups are typically benzophenone groups, acetophenone groups, benzoin groups or carbonate groups attached to a phenyl ring. Such compounds are disclosed e.g. in EP 346734, EP 377199, DE 4037079, DE 3844444, EP 1213 and US2015/0152297. Examples include but are not limited to 4-acryloxybenzophenone (=4-benzoylphenyl propenoate), 4-methacryloxybenzophenone (=4-benzoylphenyl 2-methylpropenoate), 4-(2-acryloxyethoxy)benzophenone (=2-(4-benzoylphenoxy)ethyl propenoate), 4-(2-methacryloxyethoxy)benzophenone (=2-(4-benzoylphenoxy)ethyl 2-methyl-propenoate), O-(2-(meth)acryloxyethyl)-O-(benzoylphenyl) carbonate and O-(2-(meth)acryloxyethyl)-O-(acetylphenyl) carbonate. The amounts of said monomers M7 will generally not exceed 1 pphm and, if present, are typically present in an amount of 0.01 to 1 pphm, especially in an amount of 0.02 to 0.5 pphm.

In particular, the monomers M comprise at least one monomer M4 and at least one monomer M5.

In particular, the monomers M consist of:
25 to 90% by weight, especially 30 to 85% by weight, based on the total amount of monomers M, of isobutyl acrylate in particular of isobutyl acrylate having at least 50 mol-% of bio-carbon as a monomer M1;
0 to 50% by weight, e.g. 5 to 50% by weight, especially 0 to 40% by weight or 5 to 40% by weight, based on the total amount of monomers M, of at least one monomer M2, which is selected from n-ethyl acrylate, n-butyl acrylate, n-pentyl acrylate, n-hexyl acrylate, n-octyl acrylate, 2-ethylhexyl acrylate, 2-propylheptyl acrylate and mixtures thereof, such as for example mixtures of n-butyl acrylate and 2-ethylhexylacrylate or mixtures of n-butyl acrylate and ethyl acrylate or mixtures of ethyl acrylate, n-butyl acrylate and 2-ethylhexyl acrylate and mixtures thereof;
10 to 45% by weight, especially 15 to 45% by weight, based on the total amount of monomers M, of at least one monomer M3, which is selected from tert-butyl acrylate, methyl methacrylate, ethyl methacrylate, n-butyl methacrylate, isobutyl methacrylate, tert-butyl methacrylate, cyclohexylmethacrylate, isobornylacrylate, isobornylmethacrylate and styrene and mixtures thereof;
0.05 to 4% by weight or 0.1 to 4% by weight, especially 0.05 to 3.5% by weight or 0.1 to 3.5% by weight or 0.1 to 3% by weight or 0.2 to 3% by weight or 0.5 to 3% by weight or 0.5 to 2% by weight, based on the total amount of monomers M, of one or more monoethylenically unsaturated monomers M4;
0 to 9.95% by weight, especially 0.1 to 7% by weight or 0.1 to 5% by weight, based on the total weight of the monomers M, of one or more non-ionic monomers M5;
0 to 1% by weight, especially 0 to 0.5% by weight, of one or more monomers M7;
where the total amount of monomers M1 and M2 is in the range from 50 to 89.95% by weight or 50 to 89.85% by weight or 50 to 89.8% by weight or 50 to 89.7% by weight or 50 to 89.4% by weight, especially 55 to 84.95% by weight or 55 to 84.85% by weight or 55 to 84.8% by weight or 55 to 84.7% by weight or 55 to 84.4% by weight, based on the total amount of ethylenically unsaturated monomers M, and where the total amount of monomers M1, M2 and M3 is at least 90% by weight, in particular at least 94.4% by weight or at least 94.7% by weight or at least 94.8% by weight or at least 94.9% by weight, based on the total amount of ethylenically unsaturated monomers M (group 4 of embodiments).

More particularly, the monomers M comprise:
25 to 90% by weight, especially 30 to 85% by weight, based on the total amount of monomers M, of isobutyl acrylate in particular of isobutyl acrylate having at least 50 mol-% of bio-carbon as a monomer M1;
0 to 50% by weight, e.g. 5 to 50% by weight, especially 0 to 40% by weight or 5 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
10 to 45% by weight, especially 15 to 45% by weight, based on the total amount of monomers M, of at least one monomer M3, which is selected from tert-butyl acrylate, n-butyl methacrylate, methyl methacrylate, cyclohexylmethacrylate, isobornylmethacrylate and styrene and mixtures thereof;
0.05 to 4% by weight or 0.1 to 4% by weight, especially 0.05 to 3.5% by weight or 0.1 to 3.5% by weight or 0.1 to 3% by weight or 0.2 to 3% by weight or 0.5 to 3% by weight or 0.5 to 2% by weight, based on the total amount of monomers M, of one or more monoethylenically unsaturated monomers M4;
0 to 9.95% by weight, especially 0.1 to 7% by weight or 0.1 to 5% by weight, based on the total weight of the monomers M, of one or more non-ionic monomers M5;
0 to 1% by weight, especially 0 to 0.5% by weight, of one or more monomers M7;
where the total amount of monomers M1 and M2 is in the range from 50 to 89.95% by weight or 50 to 89.85% by weight or 50 to 89.8% by weight or 50 to 89.7% by weight or 50 to 89.4% by weight, especially 55 to 84.95% by weight or 55 to 84.85% by weight or 55 to 84.8% by weight or 55 to 84.7% by weight or 55 to 84.4% by weight, based on the total amount of ethylenically unsaturated monomers M, and where the total amount of monomers M1, M2 and M3 is at least 90% by weight, in particular at least 94.4% by weight or at least 94.7% by weight or at least 94.8% by weight or at least 94.9% by weight, based on the total amount of ethylenically unsaturated monomers M (group 4a of embodiments)..

Even more preferably, the monomers M comprise:
25 to 90% by weight, especially 30 to 85% by weight, based on the total amount of monomers M, of isobutyl acrylate in particular of isobutyl acrylate having at least 50 mol-% of bio-carbon as a monomer M1;
0 to 50% by weight, e.g. 5 to 50% by weight, especially 0 to 40% by weight or 5 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
10 to 45% by weight, especially 15 to 45% by weight, based on the total amount of monomers M, of the monomer M3, which is selected from methyl methacrylate and combinations of methyl methacrylate and at least one further monomer M3, selected from tert-butyl acrylate, n-butyl methacylate, cyclohexylmethacrylate, isobornylmethacrylate and styrene;
0.05 to 4% by weight or 0.1 to 4% by weight, especially 0.05 to 3.5% by weight or 0.1 to 3.5% by weight or 0.1 to 3% by weight or 0.2 to 3% by weight or 0.5 to 3% by weight or 0.5 to 2% by weight, based on the total amount of monomers M, of one or more monoethylenically unsaturated monomers M4;
0 to 9.95% by weight, especially 0.1 to 7% by weight or 0.1 to 5% by weight, based on the total weight of the monomers M, of one or more non-ionic monomers M5;
0 to 1% by weight, especially 0 to 0.5% by weight, of one or more monomers M7;
where the total amount of monomers M1 and M2 is in the range from 50 to 89.95% by weight or 50 to 89.85% by weight or 50 to 89.8% by weight or 50 to 89.7% by weight or 50 to 89.4% by weight, especially 55 to 84.95% by weight or 55 to 84.85% by weight or 55 to 84.8% by weight or 55 to 84.7% by weight or 55 to 84.4% by weight, based on the total amount of ethylenically unsaturated monomers M, and where the total amount of monomers M1, M2 and M3 is at least 90% by weight, in particular at least 94.4% by weight or at least 94.7% by weight or at least 94.8% by weight or at least 94.9% by weight, based on the total amount of ethylenically unsaturated monomers M (group 4b of embodiments).

Especially, the monomers M comprise:
25 to 90% by weight, especially 30 to 85% by weight, based on the total amount of monomers M, of isobutyl acrylate in particular of isobutyl acrylate having at least 50 mol-% of bio-carbon as a monomer M1;
0 to 50% by weight, e.g. 5 to 50% by weight, especially 0 to 40% by weight or 5 to 40% by weight, based on the total amount of monomers M, of at least one monomer M2, which is selected from n-butyl acrylate and 2-ethylhexyl acrylate and mixtures of n-butyl acrylate and 2-ethylhexylacrylate;
10 to 45% by weight, especially 15 to 45% by weight, based on the total amount of monomers M, of methyl methacrylate as a monomer M3;
0.05 to 4% by weight or 0.1 to 4% by weight, especially 0.05 to 3.5% by weight or 0.1 to 3.5% by weight or 0.1 to 3% by weight or 0.2 to 3% by weight or 0.5 to 3% by weight or 0.5 to 2% by weight, based on the total amount of monomers M, of one or more monoethylenically unsaturated monomers M4;
0 to 9.95% by weight, especially 0.1 to 7% by weight or 0.1 to 5% by weight, based on the total weight of the monomers M, of one or more non-ionic monomers M5;
0 to 1% by weight, especially 0 to 0.5% by weight, of one or more monomers M7;
where the total amount of monomers M1 and M2 is in the range from 50 to 89.95% by weight or 50 to 89.85% by weight or 50 to 89.8% by weight or 50 to 89.7% by weight or 50 to 89.4% by weight, especially 55 to 84.95% by weight or 55 to 84.85% by weight or 55 to 84.8% by weight or 55 to 84.7% by weight or 55 to 84.4% by weight, based on the total amount of ethylenically unsaturated monomers M, and where the total amount of monomers M1, M2 and M3 is at least 90% by weight, in particular at least 94.4% by weight or at least 94.7% by weight or at least 94.8% by weight or at least 94.9% by weight, based on the total amount of ethylenically unsaturated monomers M (group 4c of embodiments).

In a particular group 5 of embodiment the type and amounts of monomers M1, M2, M3 and M4 are as defined the particular group 4 of embodiment, except that monomer M1 is isoamyl acrylate instead of isobutyl acrylate.

Amongst the particular group 5 of embodiments, preference is given to the embodiment 5a, where the type and amounts of monomers M1, M2, M3, M4 and M5 are as defined the particular group 4a of embodiments, except that monomer M1 is isoamyl acrylate instead of isobutyl acrylate.

Amongst the particular group 5 of embodiment, particular preference is given to the embodiment 5b, where the type and amounts of monomers M1, M2, M3, M4 and M5 are as defined the more preferred group 4b of embodiments, except that monomer M1 is isoamyl acrylate instead of isobutyl acrylate.

Amongst the particular group 5 of embodiment, special preference is given to the embodiment 5c, where the type and amounts of monomers M1, M2, M3, M4 and M5 are as defined the special group 4c of embodiments, except that monomer M1 is isoamyl acrylate instead of isobutyl acrylate.

In a particular group 6 of embodiment the type and amounts of monomers M1, M2, M3, M4 and M5 are as defined the particular group 4 of embodiment, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 6 of embodiment, preference is given to the embodiment 6a, where the type and amounts of monomers M1, M2, M3, M4 and M5 are as defined the particular group 4a of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 6 of embodiment, particular preference is given to the embodiment 6b, where the type and amounts of monomers M1, M2, M3, M4 and M5 are as defined the more preferred group 4b of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

Amongst the particular group 6 of embodiment, special preference is given to the embodiment 6c, where the type and amounts of monomers M1, M2, M3, M4 and M5 are as defined the special group 4c of embodiments, except that monomer M1 is a mixture comprising at least 80% by weight, based on the total amount of monomers M1 of isoamyl acrylate and 2-methylbutyl acrylate and optionally up to 20% of isobutyl acrylate, instead of isobutyl acrylate.

A further group 7 of embodiments relates to a polymer latex of the present invention, where the monomers M comprise or consist of:
a) 50 to 70% by weight, based on the total weight of monomers M, of isobutyl acrylate as a monomer M1,
b) 30 to 50% by weight, based on the total weight of monomers M, of methyl methacrylate as a monomer M3,
c) 0.1 to 4% by weight, in particular 0.2 to 3% by weight or 0.5 to 3% by weight, especially 0.5 to 2% by weight, based on the total weight of monomers M, of one or more monomers M4, which are selected from the group consisting of monoethylenically unsaturated carboxylic acids,
d) 0 to 5% by weight, in particular 0.1 to 4% by weight, preferably 0.2 to 3% by weight or 0.5 to 3% by weight, even more preferred of 1 to 3% by weight, based on the total weight of monomers M, of one or more monoethylenically unsaturated carboxylic acid amides as a monomer M5,
e) 0 to 10% by weight of one or more further ethylenically unsaturated non-ionic monomers different from monomers M1, methyl methacrylate, M4, and M5, preferably selected from the monomers M2 and M3 different from methyl methacrylate, e.g. from the group consisting of tert-butyl acrylate, n-butyl acrylate, n-pentyl acrylate, C₆-C₁₀-alkyl esters of acrylic acid, in particular 2-propylheptyl acrylate, n-octyl acrylate, 2-octyl acrylate, 2-ethylhexyl acrylate, C₂-C₁₀-alkyl esters of methacrylic acid, in particular 2-ethylhexyl methacrylate, butyl methacrylate and tert-butyl methacrylate, and vinylaromatic monomers, in particular styrene.

In group 7 of embodiments, isobutyl acrylate (IBA) and methyl methacrylate (MMA) account for at least 95% by weight of the monomer composition M. For example, isobutyl acrylate may be present in an amount of 55 to 65% by weight of the monomers M, and methyl methacrylate may be present in an amount of 35 to 45% by weight of the monomers M.

In a preferred subgroup 7a of group 7 of embodiments, the monomer composition M consists of
a) 50 to 69.8% by weight, especially 55 to 64.8% by weight, of isobutyl acrylate,
b) 30 to 49.8% by weight by weight, especially 35 to 44.8% by weight, of methyl methacrylate,
c) 0.1 to 4% by weight, in particular 0.2 to 3% by weight or 0.5 to 3% by weight, especially 0.5 to 2% by weight, of a monoethylenically unsaturated carboxylic acid,
d) 0.1 to 4% by weight, preferably 0.2 to 3% by weight or 0.5 to 3% by weight, even more preferred of 1 to 3% by weight, of a monoethylenically unsaturated carboxylic acid amide,
where the % by weight values refer to the total weight of monomers M.

In a particularly preferred subgroup 7b of group 7 of embodiments, the monomer composition M consists of
a) 50 to 69.6% by weight, especially 55 to 64.6% by weight or 55 to 64% by weight, of isobutyl acrylate,
b) 30 to 49.6% by weight, especially 35 to 44.6% by weight or 35 to 44% by weight, of methyl methacrylate,
c) 0.2 to 3% by weight, in particular 0.5 to 3% by weight, especially 0.5 to 2% by weight of a monoethylenically unsaturated carboxylic acid, selected from acrylic acid, methacrylic acid and itaconic acid,
d) 0.2 to 3% by weight, in particular 0.5 to 3% by weight, especially 0.5 to 2% by weight of a monoethylenically unsaturated carboxylic acid amide, selected from acrylamide and methacrylamide
where the % by weight values refer to the total weight of monomers M.

For example, in subgroup 7b of embodiments, the monomer composition M consists of
a) 50 to 69% by weight, especially 55 to 64% by weight of isobutyl acrylate,
b) 30 to 49% by weight, especially 35 to 44% by weight of methyl methacrylate,
c) 0.5 to 3% by weight, especially 0.5 to 2% by weight of acrylic acid,
d) 0.5 to 3% by weight, especially 0.5 to 2% by weight of acrylamide
where the % by weight values refer to the total weight of monomers M.

For example, in subgroup 7b of embodiments, the monomer composition M consists of
a) 50 to 69% by weight, especially 55 to 64% by weight of isobutyl acrylate,
b) 30 to 49% by weight, especially 35 to 44% by weight of methyl methacrylate,
c) 0.5 to 3% by weight, especially 0.5 to 2% by weight of methacrylic acid,
d) 0.5 to 3% by weight, especially 0.5 to 2% by weight of acrylamide.

In preferred embodiments of group 7 of embodiments, at least part of the isobutyl acrylate of component a) has been produced from renewable raw materials, i. e. at least part of the isobutyl acrylate of component a) is a bio-based isobutyl acrylate that has been partially or completely obtained from renewable raw materials. Also mixtures of isobutyl acrylate obtained from fossil raw materials and isobutyl acrylate partially or completely obtained from renewable raw materials can be used.

Preferably, the particles of the copolymer contained in the polymer latex have a Z-average particle diameter, as determined by QELS, in the range from 30 to 500 nm, in particular in the range from 40 to 450 nm. The particle size distribution of the copolymer particles contained in the polymer latex may be monomodal or almost monomodal, which means that the distribution function of the particle size has a single maximum and no particular shoulder. The particle size distribution of the copolymer particles contained in the polymer latex may also be polymodal or almost polymodal, which means that the distribution function of the particle size has at least two distinct maxima or at last one maximum and at least a pronounced shoulder.

If not stated otherwise, the size of the particles as well as the distribution of particle size is determined by quasielastic light scattering (QELS), also known as dynamic light scattering (DLS). The measurement method is described in the ISO 13321:1996 standard. The determination can be carried out using a High-Performance Particle Sizer (H PPS). For this purpose, a sample of the aqueous polymer latex will be diluted and the dilution will be analyzed. In the context of QELS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a non-ionic emulsifier, e.g. an ethoxylated C16/C18 alkanol (degree of ethoxylation of 18), as a diluent. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173°; wavelength laser 633 nm (HeNe); refractive index of medium 1.332 (aqueous); viscosity 0.9546 mPa-s. The measurement gives an average value of the second order cumulant analysis (mean of fits), i.e. Z average. The “mean of fits” is an average, intensity-weighted hydrodynamic particle diameter in nm.

The hydrodynamic particle diameter can also be determined by Hydrodynamic Chromatography fractionation (HDC), as for example described by H. Wiese, “Characterization of Aqueous Polymer Dispersions” in Polymer Dispersions and Their Industrial Applications (Wiley-VCH, 2002), pp. 41-73. For further details, reference is made to the examples and the description below.

In a particular group of embodiments, the particles of the copolymer contained in the polymer latex have a Z-average particle diameter, as determined by QELS, in the range from 30 to 200 nm, in particular in the range from 40 to 150 nm. In this particular group of embodiments, the particle size distribution of the copolymer particles contained in the polymer latex is in particular monomodal or almost monomodal, which means that the distribution function of the particle size has a single maximum.

In another particular group of embodiments, the particles of the copolymer contained in the polymer latex have a Z-average particle diameter, as determined by QELS, in the range from 150 to 500 nm, in particular in the range from 200 to 400 nm. In this particular group of embodiments, the particle size distribution of the copolymer particles contained in the polymer latex is in particular polymodal, in particular bimodal, which means that the distribution function of the particle size has at least two maxima. Usually, the particle size distribution, as determined by QELS, of the polymer particles in the polymer dispersion obtainable by the process as described herein has a first maximum in the range of 30 to 150 nm and a second maximum in the range of 200 to 500 nm. Preferably, said first maximum is in the range of 50 to 130 nm and said second maximum is in the range of 200 to 400 nm.

The copolymer contained in the polymer particles may form a single phase or it may form different phases, if the polymer particles contain different copolymers, which differ with regard to their monomer composition. Preferably, the polymer particles contained in the aqueous polymer latex of the present invention, comprises at least one polymer phase, where the polymer has a glass transition temperature Tg which does not exceed 40° C., in particular is at most 25° C., e.g. in the range from −25 to +40° C., in particular in the range from −20 to +25° C.

The glass transition temperatures as referred to herein are the actual glass transition temperatures. The actual glass transition temperature can be determined experimentally by the differential scanning calorimetry (DSC) method according to ISO 11357-2:2013, preferably with sample preparation according to ISO 16805:2003. According to a particular preferred group of embodiments of the invention, the polymer particles contained in the aqueous polymer latex of the present invention, comprises a polymer phase (1), which has a glass transition temperature Tg(1) in the range from −25 to +40° C., in particular in the range from −20 to +20° C. and a polymer phase (2), which has a glass transition temperature Tg(2) in the range from +50 to +150° C., in particular in the range from +60 to +120° C.

Preferably, at least 75% by weight of the monomer M1, based on the total amount of the monomer M1 present in the monomers M, are present in the polymer phase (1).

The actual glass transition temperature depends from the monomer compositions forming the respective polymer phases (1) and (2), respectively, and a theoretical glass transition temperature can be calculated from the monomer composition used in the emulsion polymerization. The theoretical glass transition temperatures are usually calculated from the monomer composition by the Fox equation:

1/Tg^{t}=xₐ/Tgₐ+x_{b}/Tg_{b}+ . . . xₙ/Tgₙ,

In this equation xₐ, x_{b}, . . . x_{N} are the mass fractions of the monomers a, b, . . . n and Tgₐ, Tg_{b}, . . . Tgₙ are the actual glass transition temperatures in Kelvin of the homopolymers synthesized from only one of the monomers 1, 2, . . . n at a time. The Fox equation is described by T. G. Fox in Bull. Am. Phys. Soc. 1956, 1, page 123 and as well as in Ullmann's Encyclopsdie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopsdie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

Usually, the theoretical glass temperature Tg^{t} calculated according to Fox as described herein and the experimentally determined glass transition temperature as described herein are similar or even same and do not deviate from each other by more than 5 K, in particular they deviate not more than 2 K. Accordingly, both the actual and the theoretical glass transition temperatures of the polymer phases (1) and (2) can be adjusted by choosing proper monomers Ma, Mb . . . Mn and their mass fractions xₐ, x_{b}, . . . xₙ in the monomer composition so to arrive at the desired glass transition temperature Tg(1) and Tg(2), respectively. It is common knowledge for a skilled person to choose the proper amounts of monomers Ma, Mb . . . Mn for obtaining a copolymer and/or copolymer phase with the desired glass transition temperature.

The monomer composition forming the polymer phase (1) is preferably chosen such that the theoretical glass transition temperature Tg^{t}(1) is preferably in the range of −25 to +40° C. and especially in the range of −20 to 20° C. Likewise, the monomer composition forming the polymer phase (2) is chosen such that the theoretical glass transition temperature Tg^{t}(2) is preferably in the range of +50 to +150° C., more preferably in the range of 60 to 120° C.

In particular, the relative amount of monomers forming the polymer phase (1) and the monomers forming the polymer phase (2) are chosen such that the monomers M comprise
50 to 95 wt.-%, preferably 60 to 90 wt.-%, based on the total amount of the monomers M, of monomers forming the polymer phase (1) having the lower glass transition temperature Tg(1) and
5 to 50 wt.-%, preferably 10 to 40 wt.-%, based on the total amount of the monomers M, of monomers forming the polymer phase (2) having the higher glass transition temperature Tg(2).

Consequently, the polymer particles contained in the polymer dispersion obtainable by the process according to the present invention comprise
50 to 95 wt.-%, preferably 60 to 90 wt.-%, based on the total weight of the polymer particles, of the polymer phase (1) having the lower glass transition temperature Tg(1) and
5 to 50 wt.-%, preferably 10 to 40 wt.-%, based on the total weight of the polymer particles, of the polymer phase (2) having the higher glass transition temperature Tg(2).

It is apparent to the skilled person, that the monomers M forming the polymer phase (1) and the monomers M forming the polymer phase (2) may be distinct with regard to the type of monomers and/or with regard to their relative amounts. Apparently, the monomers M forming the polymer phase (2) will contain a higher amount of monomers which result in a high glass transition temperature. In one group of embodiments, the relative amount of monomers M3 is higher in the monomers M forming the polymer phase (2) than in the monomers M forming the polymer phase (1). In another group of embodiments, the relative amount of monomers M3 is higher in the monomers M forming the polymer phase (1) than in the monomers M forming the polymer phase (2).

However, the overall composition of the monomers M forming the polymer phase (1) and the monomers M forming the polymer phase (2) is in the ranges given above.

Preferably, the aqueous polymer dispersions of the present invention have a pH of at least pH 6, e.g. in the range of pH 6 to pH 9.

The aqueous polymer dispersions of the present invention generally have solids contents in the range of 30 to 75% by weight, preferably in the range of 40 to 65% by weight, in particular in the range of 45 to 60% by weight. The solids content describes the proportion of nonvolatile fractions. The solids content of a dispersion is determined by means of a balance with infrared moisture analysis. In this determination, a quantity of polymer dispersion is introduced into the instrument, heated to 140° C. and subsequently held at that temperature. As soon as the average decrease in weight falls below 1 mg within 140 seconds, the measurement procedure is ended. The ratio of weight after drying to original mass introduced gives the solids content of the polymer dispersion. The total solids content of the formulation is determined arithmetically from the amounts of the substances added and from their solids contents and concentrations.

The polymer dispersions may contain a crosslinking agent for achieving post-crosslinking of the polymer latex particles, if the polymer in the polymer latex has functional groups which are complementary to the functional groups of the crosslinking agent. In this context, the term “complementary” is understood that the functional groups of the latex and the functional groups of the crosslinking agent are susceptible to undergo a chemical reaction which forms a chemical bond between the atoms of the respective functional groups. Typically, the crosslinking agent has at least two functional groups complementary to the functional groups of the polymer of the polymer latex. Examples of suitable crosslinking agents are described below.

Besides the polymer and the optional crosslinking agent, the aqueous polymer dispersions of the present invention may contain further ingredients conventionally present in aqueous polymer dispersions. These further ingredients are, for example, surface active compounds, such as emulsifiers und protective colloids, in particular those used in the production of the polymer latex, further defoamers and the like. Further ingredients may also be acids, bases, buffers, decomposition products from the polymerization reaction, deodorizing compounds, and chain transfer agents. Furthermore, the polymer latex may contain biozides for avoiding microbial spoilage. The amount of the respective individual component will typically not exceed 1.5 wt %, based on the total weight of the polymer dispersion. The total amount of these stated components will typically not exceed 5 wt %, based on the total weight of the polymer latex.

Preferably, the amount of volatile organic matter, i.e. the content of organic compounds with boiling points up to 250° C. under standard conditions (101,325 kPa) as determined by ISO 17895:2005 via gas-chromatography is less than 0.5% by weight, in particular less than 0.2% by weight, based on the total weight of the polymer latex.

Besides the polymer, the aqueous polymer latex also contains an aqueous phase, wherein the polymer particles of the polymer latex are dispersed. The aqueous phase, also termed serum, consists essentially of water and any water-soluble further ingredients. The total concentration of any further ingredient will typically not exceed 10 wt %, in particular 8% by weight, based on the total weight of the aqueous phase.

The aqueous polymer latex of the present invention can be prepared by any method for preparing an aqueous dispersion of a polymer made of polymerized monomers M. In particular, aqueous polymer latexes of the present invention are prepared by an aqueous emulsion polymerization, in particular by a free radical aqueous emulsion polymerization of the monomers M. The term “free radical aqueous emulsion polymerization” means that the polymerization of the monomers M is initiated by radicals formed by the decay of a polymerization initiator, whereby free radicals are formed in the polymerization mixture. It is therefore also termed “radically initiated emulsion polymerization”. The procedure for radically initiated emulsion polymerizations of monomers in an aqueous medium has been extensively described and is therefore sufficiently familiar to the skilled person [cf. in this regard Emulsion Polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422; and Dispersionen synthetischer Hochpolymerer, F. Hölscher, Springer-Verlag, Berlin (1969)]. Typical procedures for aqueous emulsion polymerization of ethylenically unsaturated monomers are also described in the patent literature discussed in the introductory part of this patent application.

The radically initiated aqueous emulsion polymerization is typically carried out by emulsifying the ethylenically unsaturated monomers in the aqueous medium which forms the aqueous phase, typically by use of surface active compounds, such as emulsifiers and/or protective colloids, and polymerizing this system using at least one initiator which decays by formation of radicals and thereby initiates the chain growth addition polymerization of the ethylenically unsaturated monomers M. The preparation of an aqueous polymer dispersion in accordance with the present invention may differ from this general procedure only in the specific use of the aforementioned monomers M1 to M8. It will be appreciated here that the process shall, for the purposes of the present specification, also encompass the seed, staged, one-shot, and gradient regimes which are familiar to the skilled person.

The free-radically initiated aqueous emulsion polymerization is triggered by means of a free-radical polymerization initiator (free-radical initiator). These may, in principle, be peroxides or azo compounds. Of course, redox initiator systems are also useful. Peroxides used may, in principle, be inorganic peroxides such as hydrogen peroxide or peroxodisulfates such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide and also dialkyl or diaryl peroxides such as di-tert-butyl or di-cumyl peroxide. Azo compounds used are essentially 2,2′-azobis(isobutyronitrile), 2,2′-azobis(2,4-dimethylvaleronitrile) and 2,2′-azobis(amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols such as dihydroxymaleic acid, benzoin and/or ascorbic acid, and reducing saccharides such as sorbose, glucose, fructose and/or dihydroxyacetone.

Preferred free-radical initiators are inorganic peroxides, especially peroxodisulfates.

In general, the amount of the free-radical initiator used, based on the total amount of monomers M, is 0.05 to 2 pphm, preferably 0.1 to 1 pphm, based on the total amount of monomers M.

The amount of free-radical initiator required for the emulsion polymerization of monomers M can be initially charged in the polymerization vessel completely. However, it is also possible to charge none of or merely a portion of the free-radical initiator, for example not more than 30% by weight, especially not more than 20% by weight, based on the total amount of the free-radical initiator and then to add any remaining amount of free-radical initiator to the free-radical polymerization reaction under polymerization conditions. Preferably, at least 70%, in particular at least 80%, especially at least 90% or the total amount of the polymerization initiator are fed to the free-radical polymerization reaction under polymerization conditions. Feeding of the monomers M may be done according to the consumption, batch-wise in one or more portions or continuously with constant or varying flow rates during the free-radical emulsion polymerization of the monomers M.

Generally, the term “polymerization conditions” is understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected, such that a sufficient amount of initiating radicals is always present to initiate or to maintain the polymerization reaction.

Preferably, the radical emulsion polymerization of the monomers M is performed by a so-called feed process (also termed monomer feed method), which means that at least 80%, in particular at least 90% or the total amount of the monomers M to be polymerized are metered to the polymerization reaction under polymerization conditions during a metering period P. Addition may be done in portions and preferably continuously with constant or varying feed rate. The duration of the period P may depend from the production equipment and may vary from e.g. 20 minutes to 12 h. Frequently, the duration of the period P will be in the range from 0.5 h to 8 h, especially from 1 h to 6 h. In a multistep emulsion polymerization step, the total duration of all steps is typically in the above ranges. The duration of the individual steps is typically shorter. Preferably, at least 70%, in particular at least 80%, especially at least 90% or the total amount of the polymerization initiator is introduced into emulsion polymerization in parallel to the addition of the monomers.

The aqueous radical emulsion polymerization is usually performed in the presence of one or more suitable surfactants. These surfactants typically comprise emulsifiers and provide micelles, in which the polymerization occurs, and which serve to stabilize the monomer droplets during aqueous emulsion polymerization and also growing polymer particles. The surfactants used in the emulsion polymerization are usually not separated from the polymer dispersion, but remain in the aqueous polymer dispersion obtainable by the emulsion polymerization of the monomers M.

The surfactant may be selected from emulsifiers and protective colloids. Protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

Anionic surfactants usually bear at least one anionic group which is typically selected from phosphate, phosphonate, sulfate and sulfonate groups. The anionic surfactants which bear at least one anionic group are typically used in the form of their alkali metal salts, especially of their sodium salts or in the form of their ammonium salts.

Preferred anionic surfactants are anionic emulsifiers, in particular those which bear at least one sulfate or sulfonate group. Likewise, anionic emulsifiers which bear at least one phosphate or phosphonate group may be used, either as sole anionic emulsifiers or in combination with one or more anionic emulsifiers which bear at least one sulfate or sulfonate group.

Examples of anionic emulsifiers which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40,
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₃-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂-alkyl group on one or both aromatic rings. The latter are common knowledge, for example from U.S. Pat. No. 4,269,749, and are commercially available, for example as Dowfax® 2A1 (Dow Chemical Company),
surfactants, which have a polymerizable ethylenically unsaturated double bond as described herein, e.g. the compounds of the formulae (I)-(IV), where X and Y, respectively, are SO₃⁻ or O—SO₃⁻.

Examples of anionic emulsifiers which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of alkylphosphonic acids, especially C₈-C₂₂-alkylphosphonic acids and
the salts, especially the alkali metal and ammonium salts, of alkylbenzenephosphonic acids, especially C₄-C₂₂-alkylbenzenephosphonic acids.
surfactants, which have a polymerizable ethylenically unsaturated double bond as described herein, e.g. the compounds of the formulae (I)-(IV), where X and Y, respectively, are HPO₃⁻, PO₃², O—HPO₃⁻ or O—PO₃².

Anionic emulsifiers may also comprise emulsifiers, which have a polymerizable double bond, e.g. the emulsifiers of the formulae (I) to (IV) and the salts thereof, in particular the alkalimetal salts or ammonium salts thereof:

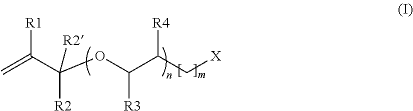

In formula (I), R¹ is H, C₁-C₂₀-alkyl, C₅-C₁₀-cycloalkyl, phenyl optionally substituted with C₁-C₂₀-alkyl, R² and R^{2′} are both H or together are O, R³ and R⁴ are H or methyl, m is 0 or 1, n is an integer from 1-100 and X is SO₃⁻, O—SO₃⁻, O—HPO₃⁻ or O—PO₃²⁻.

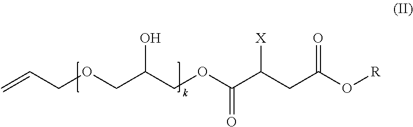

In formula (II), R is H, C₁-C₂₀-alkyl, C₅-C₁₀-cycloalkyl, phenyl optionally substituted with C₁-C₂₀-alkyl, k is 0 or 1 and X is SO₃⁻, O—SO₃⁻, O—HPO₃⁻ or O—PO₃²⁻.

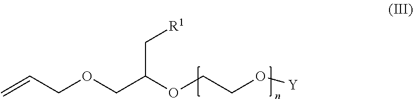

In formula (III), R¹ is H, C₁-C₂₀-alkyl, O—C₁-C₂₀-alkyl, C₅-C₁₀-cycloalkyl, O—C₅-C₁₀-cycloalkyl, O-phenyl optionally substituted with C₁-C₂₀-alkyl, n is an integer from 1-100 and Y is SO₃⁻, HPO₃⁻ or PO₃²⁻.

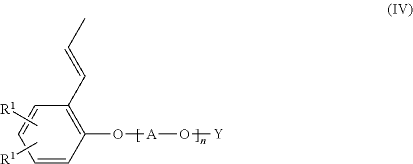

In formula (IV), R¹ is H, C₁-C₂₀-alkyl or 1-phenylethyl, R² is H, C₁-C₂₀-alkyl or 1-phenylethyl, A is C₂-C₄-alkanediyl, such as 1,2-ethanediyl, 1,2-propanediyl, 1,2-butanediyl or 1,4-butanediyl, n is an integer from 1-100 and Y is SO₃⁻, HPO₃⁻ or PO₃²⁻.

Particular embodiments of the copolymerizable emulsifiers of the formula (I) are referred to as sulfate esters or phosphate esters of polyethylene glycol monoacrylates. Particular embodiments of the copolymerizable emulsifiers of the formula (I) may likewise also be referred to as phosphonate esters of polyethylene glycol monoacrylates, or allyl ether sulfates. Commercially available co-polymerizable emulsifiers of the formula (I) are Maxemul® emulsifiers, Sipomer® PAM emulsifiers, Latemul® PD, and ADEKA Reasoap® PP-70.

Particular embodiments of the copolymerizable emulsifiers of the formula (II) are also referred to as alkyl allyl sulfosuccinates. Commercially available copolymerizable emulsifiers of the formula (II) is Trem® LF40.

Particular embodiments of the copolymerizable emulsifiers of the formula (III) are also referred to as branched unsaturated. Commercially available copolymerizable emulsifiers of the formula (III) are Adeka® Reasoap emulsifiers and Hitenol® KH.

Particular embodiments of the copolymerizable emulsifiers of the formula (IV) are also referred to as polyoxyethylene alkylphenyl ether sulfate and polyoxyethylene mono- or distyrylphenyl ether sulfate. Commercially available copolymerizable emulsifiers of the formula (IV) are Hitenol® BC and Hitenol® AR emulsifiers.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

Preferably, the surfactant comprises at least one anionic emulsifier which bears at least one sulfate or sulfonate group. The at least one anionic emulsifier which bears at least one sulfate or sulfonate group, may be the sole type of anionic emulsifiers. However, mixtures of at least one anionic emulsifier which bears at least one sulfate or sulfonate group and at least one anionic emulsifier which bears at least one phosphate or phosphonate group may also be used. In such mixtures, the amount of the at least one anionic emulsifier which bears at least one sulfate or sulfonate group is preferably at least 50% by weight, based on the total weight of anionic surfactants used in the process of the present invention. In particular, the amount of anionic emulsifiers which bear at least one phosphate or phosphonate group does not exceed 20% by weight, based on the total weight of anionic surfactants used in the process of the present invention.

Preferred anionic surfactants are anionic emulsifiers which are selected from the following groups, including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of sulfuric monoesters of ethoxylated alkylphenols, especially of sulfuric monoesters of ethoxylated C₄-C₁₃-alkylphenols (EO level preferably 3 to 40),
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.
polymerizable emulsifiers of the formula (III).

Particular preference is given to anionic emulsifiers which are selected from the following groups including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of mono- or disulfonated, alkyl-substituted diphenyl ethers, for example of bis(phenylsulfonic acid) ethers bearing a C₄-C₂₄-alkyl group on one or both aromatic rings
polymerizable emulsifiers of the formula (III), where Y is SO₃⁻.

As well as the aforementioned anionic surfactants, the surfactant may also comprise one or more nonionic surface-active substances which are especially selected from nonionic emulsifiers. Suitable nonionic emulsifiers are e.g. araliphatic or aliphatic nonionic emulsifiers, for example ethoxylated mono-, di- and trialkylphenols (EO level: 3 to 50, alkyl radical: C₄-C₁₀), ethoxylates of long-chain alcohols (EO level: 3 to 100, alkyl radical: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols, in particular to those, where the alkyl radical C₈-C₃₀ having a mean ethoxylation level of 5 to 100 and, among these, particular preference to those having a linear C₁₂-C₂₀ alkyl radical and a mean ethoxylation level of 10 to 50 and also to ethoxylated monoalkylphenols.

The surfactants used in the process of the present invention will usually comprise not more than 30% by weight, especially not more than 20% by weight, of nonionic surfactants based on the total amount of surfactants used in the process of the present invention and especially do not comprise any nonionic surfactant. Combinations of at least one anionic surfactant and at least non-ionic surfactant may also be used. In this case, the weight ratio of the total amount of anionic surfactant to the total amount of non-ionic surfactant is in the range of 99:1 to 70:30, in particular 98:2 to 75:25, especially in the range 95:5 to 80:20.

Preferably, the surfactant will be used in such an amount that the amount of surfactant is in the range from 0.2 to 5% by weight, especially in the range from 0.3 to 4.5% by weight, based on the monomers M to be polymerized. In a multistep emulsion step emulsion polymerization, the surfactant will be used in such an amount that the amount of surfactant is usually in the range from 0.2 to 5% by weight, especially in the range from 0.3 to 4.5% by weight, based on the total amount of monomers polymerized in the respective steps.

Preferably, the major portion, i.e. at least 80% of the surfactant used, is added to the emulsion polymerization in parallel to the addition of the monomers. In particular, the monomers are added as an aqueous emulsion to the polymerization reaction which contains at least 80% of the surfactant used in the emulsion polymerization.

It has been found advantageous to perform the free-radical emulsion polymerization of the monomers M in the presence of a seed latex. A seed latex is a polymer latex which is present in the aqueous polymerization medium before the polymerization of monomers M is started. The seed latex may help to better adjust the particle size or the final polymer latex obtained in the free-radical emulsion polymerization of the invention.

Principally, every polymer latex may serve as a seed latex. For the purpose of the invention, preference is given to seed latices, where the particle size of the polymer particles is comparatively small. In particular, the Z average particle diameter of the polymer particles of the seed latex, as determined by dynamic light scattering (DLS) at 20° C. (see below), is preferably in the range from 10 to 80 nm, in particular from 10 to 50 nm. Preferably, the polymer particles of the seed latex is made of ethylenically unsaturated monomers which comprise at least 95% by weight, based on the total weight of the monomers forming the seed latex, of one or more monomers selected from the group consisting of C₂-C₁₀-alkyl esters of acrylic acid, in particular ethyl acrylate, n-butyl acrylate, n-hexyl acrylate, n-octyl acrylate, 2-ethyl-hexylacrylate, C₁-C₄-alkyl methacrylates such as methyl methacrylate, monoethylenically unsaturated nitriles, such as acrylonitrile and vinylaromatic monomers as defined above such as styrene and mixtures thereof. In particular, the polymer particles of the seed latex is made of ethylenically unsaturated monomers which comprise at least 95% by weight, based on the total weight of the monomers forming the seed latex, of one or more monomers selected from the group consisting of C₁-C₄-alkyl methacrylates such as methyl methacrylate, monoethylenically unsaturated nitriles, such as acrylonitrile and vinylaromatic monomers as defined above such as styrene and mixtures thereof.

For this, the seed latex is usually charged into the polymerization vessel before the polymerization of the monomers M is started. In particular, the seed latex is charged into the polymerization vessel followed by establishing the polymerization conditions, e.g. by heating the mixture to polymerization temperature. It may be beneficial to charge at least a portion of the free-radical initiator into the polymerization vessel before the addition of the monomers M is started. However, it is also possible to add the monomers M and the free-radical polymerization initiator in parallel to the polymerization vessel.

The amount of seed latex, calculated as solids, may frequently be in the range of 0.01 to 10% by weight, preferably in the range of 0.05 to 5% by weight, in particular in the range of 0.05 to 3% by weight, based on the total weight of the monomers in the monomer composition M to be polymerized.

The free-radical aqueous emulsion polymerization of the invention can be carried out at temperatures in the range from 0 to 170° C. Temperatures employed are generally in the range from 50 to 120° C., frequently 60 to 120° C. and often 70 to 110° C. The free-radical aqueous emulsion polymerization of the invention can be conducted at a pressure of less than, equal to or greater than 1 atm (atmospheric pressure), and so the polymerization temperature may exceed 100° C. and may be up to 170° C. Polymerization of the monomers is normally performed at ambient pressure, but it may also be performed under elevated pressure. In this case, the pressure may assume values of 1.2, 1.5, 2, 5, 10, 15 bar (absolute) or even higher values. If emulsion polymerizations are conducted under reduced pressure, pressures of 950 mbar, frequently of 900 mbar and often 850 mbar (absolute) are established. Advantageously, the free-radical aqueous emulsion polymerization of the invention is conducted at ambient pressure (about 1 atm) with exclusion of oxygen, for example under an inert gas atmosphere, for example under nitrogen or argon.

The process for producing the polymer latex of the present invention may be a single stage polymerization or a multistage emulsion polymerization. In a single stage polymerization, the overall composition of the monomers M, which are fed to the polymerization reaction under polymerization conditions, remains the same or almost the same, while in a multistage emulsion polymerization the overall composition of the monomers M, which are fed to the polymerization reaction under polymerization conditions, is altered at least once, in particular such that the theoretical glass transition temperature of the resulting polymer formed in one stage differs from the theoretical glass transition temperature of the resulting polymer formed in another stage by at least 10° C., in particular by at least 20° C. or at least 40° C.

In a particular group of embodiments, the process of the invention is performed as a 2-stage emulsion polymerization, i.e. the composition of the monomers, which are fed to the polymerization reaction under polymerization conditions, is amended once, or as a 3- or 4-stage emulsion polymerization, i.e. the composition of the monomers, which are fed to the polymerization reaction under polymerization conditions, is amended twice or trice.

In particular, the aqueous emulsion polymerization is a multistage aqueous emulsion polymerization, which comprises
i. a first stage of aqueous emulsion polymerizing a monomer composition Mⁱ, which corresponds to a theoretical glass transition temperature Tg^{t}(i) according to Fox in the range from −25 to +40° C., in particular in the range from −20 to +20° C. to obtain a first stage polymer latex, and a
ii. a second stage of aqueous emulsion polymerizing a monomer composition Mⁱⁱ, in the first stage polymer latex, where the monomer composition Mⁱⁱ corresponds to a theoretical glass transition temperature Tg^{t}(ii) according to Fox in the range from 50 to 150° C., in particular in the range from 60 to 120° C.;
or which alternatively comprises
i. a first stage of aqueous emulsion polymerizing a monomer composition Mⁱ, which corresponds to a theoretical glass transition temperature Tg^{t}(i) according to Fox in the range from 50 to 150° C., in particular in the range from 60 to 120° C. to obtain a first stage polymer latex, and a
ii. a second stage of aqueous emulsion polymerizing a monomer composition Mⁱⁱ, in the first stage polymer latex, where the monomer composition Mⁱⁱ corresponds to a theoretical glass transition temperature Tg^{t}(ii) according to Fox in the range from −25 to +40° C., in particular in the range from −20 to +20° C.

In these multistage aqueous emulsion polymerization, the monomer composition corresponding to the theoretical glass transition temperature in the range from −25 to +40° C., in particular in the range from −20 to +20° C., preferably contributes 50 to 95 wt.-%, more preferably 60 to 90 wt.-% to the overall amount of monomers M, while the monomer composition corresponding to the theoretical glass transition temperature in the range from 50 to 150° C., in particular in the range from 60 to 120° C., preferably contributes 5 to 50 wt.-%, more preferably 10 to 40 wt.-%, to the overall amount of monomers M.

In a particular group of embodiments, the aqueous emulsion polymerization is a multistage aqueous emulsion polymerization, which comprises
i. a first stage of aqueous emulsion polymerizing a monomer composition Mⁱ, which corresponds to a theoretical glass transition temperature Tg^{t}(i) according to Fox in the range from 50 to 150° C., in particular in the range from 60 to 120° C. to obtain a first stage polymer latex, where the monomer composition Mⁱ comprises from 0.5 to 10% by weight, based on the overall weight of the monomer composition Mⁱ, of at least one monomer M4,
ii. a second stage of aqueous emulsion polymerizing a monomer composition Mⁱⁱ, in the first stage polymer latex, where the monomer composition Mⁱⁱ corresponds to a theoretical glass transition temperature Tg^{t}(ii) according to Fox in the range from −25 to +40° C., in particular in the range from −20 to +20° C., where the monomer composition Mⁱⁱ comprises at most 0.5% by weight, based on the overall weight of the monomer composition Mⁱⁱ, of one or more monomers M4,
where the polymer latex obtained in step i. is neutralized to a pH of at least pH 5 prior to performing the second stage of aqueous emulsion polymerization of step ii.

In this particular group of embodiments, the monomer composition Mⁱ preferably contributes 5 to 50 wt.-%, more preferably 10 to 40 wt.-% to the overall amount of monomers M, while the monomer composition Mⁱⁱ preferably contribute 50 to 95 wt.-%, preferably 60 to 90 wt.-%, to the overall amount of monomers M.

In this particular group of embodiments, the monomer composition Mⁱ is preferably polymerized in the presence of a chain transfer agent as described below. The amount of chain transfer agent may be in the range from 0.05 to 8% by weight, in particular in the range from 0.1 to 4% by weight, based on the total amount of the monomer composition Mⁱ.

The polymerization of the monomers M can optionally be conducted in the presence of chain transfer agents. Chain transfer agents are understood to mean compounds that transfer free radicals, and which reduce the molecular weight of the growing chain and/or which control chain growth in the polymerization. Examples of chain transfer agents are aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, for example ethanethiol, n-propanethiol, 2-propanethiol, n-butanethiol, 2-butanethiol, 2-methyl-2-propanethiol, n-pentanethiol, 2 pentanethiol, 3-pentanethiol, 2-methyl-2-butanethiol, 3-methyl-2-butanethiol, n hexanethiol, 2-hexanethiol, 3-hexanethiol, 2-methyl-2-pentanethiol, 3-methyl-2 pentanethiol, 4-methyl-2-pentanethiol, 2-methyl-3-pentanethiol, 3-methyl-3 pentanethiol, 2-ethylbutanethiol, 2-ethyl-2-butanethiol, n-heptanethiol and the isomeric compounds thereof, n-octanethiol and the isomeric compounds thereof, n nonanethiol and the isomeric compounds thereof, n-decanethiol and the isomeric compounds thereof, n-undecanethiol and the isomeric compounds thereof, n dodecanethiol and the isomeric compounds thereof, n-tridecanethiol and isomeric compounds thereof, substituted thiols, for example 2-hydroxyethanethiol, aromatic thiols such as benzenethiol, ortho-, meta- or para-methylbenzenethiol, alkyl esters of mercaptoacetic acid (thioglycolic acid), such as 2-ethylhexyl thioglycolate, alkyl esters of mercaptopropionic acid, such as octyl mercapto propionate, and also further sulfur compounds described in Polymer Handbook, 3rd edition, 1989, J. Brandrup and E.H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes having nonconjugated double bonds, such as divinylmethane or vinylcyclohexane, or hydrocarbons having readily abstractable hydrogen atoms, for example toluene.

Alternatively, it is possible to use mixtures of the aforementioned chain transfer agents that do not disrupt one another. The total amount of chain transfer agents optionally used in the process of the invention, based on the total amount of monomers M, will generally not exceed 2% by weight, in particular 1% by weight. However, it is possible, that during a certain period of the polymerization reaction the amount of chain transfer agent added to the polymerization reaction may exceed the value of 2% by weight and may be as high as 8% by weight, in particular at most 4% by weight, based on the total amount of monomers M added to the polymerization reaction during said period.

It is frequently advantageous, when the aqueous polymer dispersion obtained on completion of polymerization of the monomers M is subjected to an after-treatment to reduce the residual monomer content. This after-treatment is effected either chemically, for example by completing the polymerization reaction using a more effective free-radical initiator system (known as postpolymerization), and/or physically, for example by stripping the aqueous polymer dispersion with steam or inert gas. Corresponding chemical and physical methods are familiar to those skilled in the art—see, for example, EP-A 771328, DE-A 19624299, DE-A 19621027, DE-A 19741184, DE-A 19741187, DE-A 19805122, DE-A 19828183, DE-A 19839199, DE-A 19840586 and DE-A 19847115. The combination of chemical and physical after-treatment has the advantage that it removes not only the unconverted ethylenically unsaturated monomers, but also other disruptive volatile organic constituents (VOCs) from the aqueous polymer dispersion.

As the polymer contained in the aqueous polymer dispersion may contain acidic groups from the monomers M4 and optionally from the polymerization initiator, the aqueous polymer dispersion obtained by the process of the invention is frequently neutralized prior to formulating it as a coating composition. The neutralization of acid groups of the polymer is achieved by neutralizing agents known to the skilled of the art after polymerization and/or during the polymerization. For example, the neutralizing agent may be added in a joint feed with the monomers to be polymerized or in a separate feed. Suitable neutralizing agents include organic amines, alkali hydroxides, ammonium hydroxides. In particular, neutralization is achieved by using ammonia or alkali hydroxides such as sodium hydroxide or potassium hydroxide.

Furthermore, it might be suitable to formulate the polymer latex of the invention with a post-curing agent. Ideally, such a post-curing agent, also termed as post-crosslinking agent, will result in a crosslinking reaction during and/or after film formation by forming coordinative or covalent bonds with reactive sites on the surface of the polymer particles.

Crosslinking agents, which are suitable for providing post crosslinking, are for example compounds having at least two functional groups selected from oxazoline, amino, aldehyde, aminoxy, carbodiimide, aziridinyl, epoxy and hydrazide groups, derivatives or compounds bearing acetoacetyl groups. These crosslinkers react with reactive sites of the polymers of the polymer dispersion which bear complementary functional groups in the polymer, which are capable of forming a covalent bond with the crosslinker. Suitable systems are known to skilled persons.

As the polymers contained in the polymer dispersion of the invention bear carboxyl groups, post-crosslinking can be achieved by formulation of the polymer dispersion with one or more polycarbodiimides as described in U.S. Pat. Nos. 4,977,219, 5,047,588, 5,117,059, EP 0277361, EP 0507407, EP 0628582, U.S. Pat. No. 5,352,400, US 2011/0151128 and US 2011/0217471. It is assumed that crosslinking is based on the reaction of the carboxyl groups of the polymers with polycarbodiimides. The reaction typically results in covalent cross-links which are predominately based on N-acyl urea bounds (J. W. Taylor and D. R. Bassett, in E. J. Glass (Ed.), Technology for Waterborne Coatings, ACS Symposium Series 663, Am. Chem. Soc., Washington, DC, 1997, chapter 8, pages 137 to 163).

Likewise, as the polymer particles contained in the polymer dispersion of the present invention bear carboxyl groups stemming from monomers M4, a suitable post-curing agent may also be a water-soluble or water-dispersible polymer bearing oxazoline groups, e.g. the polymers as described in U.S. Pat. No. 5,300,602 and WO 2015/197662.

Post crosslinking can also be achieved by analogy to EP 1227116, which describes aqueous two-component coating compositions containing a binder polymer with carboxylic acid and hydroxyl functional groups and a polyfunctional crosslinker having functional groups selected from isocyanate, carbodiimide, aziridinyl and epoxy groups.

If the polymer in the polymer dispersion bears a keto group, e.g. by using a monomer M5c such as diacetone acrylamide (DAAM), post-crosslinking can be achieved by formulating the aqueous polymer dispersion with one or more dihydrazides, in particular aliphatic dicarboxylic acid such as adipic acid dihydrazide (ADDH) as described in U.S. Pat. No. 4,931,494, US 2006/247367 and US 2004/143058. These components react basically during and after film formation, although a certain extent of preliminary reaction can occur.

Other suitable agents of achieving post-curing include
epoxysilanes to crosslink carboxy groups in the polymer;
dialdehydes such as glyoxal to crosslink urea groups or acetoacetoxy groups, such as those derived from the monomers M5b and M5c, respectively, as defined herein, in particular ureido (meth)acrylate or acetoacetoxyethyl (meth)acrylate;
di- and/or polyamines to crosslink keto groups or epoxy groups such as those derived from the monomers M5c or M6b as defined herein; and
UV initiators such as benzophenones, including benzophenone, 4-methoxybenzophenone, 4-methylbenzophenone, 2,4,6-trimethylbenzophenone, acetophenones, such as 2-hydroxy-2,2-dimethylacetophenone, 2-phenyl-2,2-dimethylacetophenone, cycloalkylphenyl ketones, such as 1-benzoylcyclohexan-1-ol (=1-hydroxycyclhexylphenyl ketone) and benzoins and mixtures thereof, in particular liquid mixtures such as mixtures of 4-methylbenzophenone and benzophenone, mixtures of 2,4,6-trimethylbenzophenone and benzophenone and mixtures of 1-hydroxycyclhexylphenyl ketone and benzophenone.

Suitable systems are e.g. described in EP 355028, EP 441221, EP 0789724, U.S. Pat. Nos. 5,516,453 and 5,498,659 and/or commercially available, e.g. in case of UV initiators from Omnirad and IGM Resins (e.g. Esacure TZM, Esacure TZT, Omnirad 4MBZ).

The present invention also relates to waterborne coating compositions, which contain a polymer latex of the present invention as a binder or as a co-binder. In particular, the present invention also relates to waterborne coating compositions, where the polymer latex is the sole binder or amounts to at least 80% of binder contained in the coating composition.

The waterborne coating compositions of the invention may be formulated as a clear coat or a as a paint. In the latter case, the waterborne coating compositions contain, in addition to the polymer latex, at least one inorganic pigment, which imparts a white shade or a color to the coating obtained when using the waterborne coating composition for coating substrates.

Pigments for the purposes of the present invention are virtually insoluble, finely dispersed, organic or preferably inorganic colorants as per the definition in German standard specification DIN 55944:2003-11. Examples of pigments are in particular inorganic pigments, such as white pigments like titanium dioxide (C.I. Pigment White 6), but also color pigments, e.g.
black pigments, such as iron oxide black (C.I. Pigment Black 11), iron manganese black, spinel black (C.I. Pigment Black 27), carbon black (C.I. Pigment Black 7);
color pigments, such as chromium oxide, chromium oxide hydrate green; chrome green (C.I. Pigment Green 48); cobalt green (C.I. Pigment Green 50); ultramarine green; cobalt blue (C.I. Pigment Blue 28 und 36); ultramarine blue, iron blue (C.I. Pigment Blue 27), manganese blue, ultramarine violet, cobalt violet, manganese violet, iron oxide read (C.I. Pigment Red 101); cadmium sulfoselenide (C.I. Pigment Red 108); molybdate read (C.I. Pigment Red 104); ultramarine read,
iron oxide brown, mixed brown, spinel- and Korundum phases (C.I. Pigment Brown 24, 29 und 31), chrome orange;
iron oxide yellow (C.I. Pigment Yellow 42); nickel titanium yellow (C.I. Pigment Yellow 53; C.I. Pigment Yellow 157 und 164); chrome titanium yellow; cadmium sulfide und cadmium zinc sulfide (C.I. Pigment Yellow 37 und 35); Chrome yellow (C.I. Pigment Yellow 34), zinc yellow, alkaline earth metal chromates; Naples yellow; bismuth vanadate (C.I. Pigment Yellow 184);
Interference pigments, such as metallic effect pigments based on coated metal platelets, pearl luster pigments based on mica platelets coated with metal oxide, and liquid crystal pigments.

The water-borne coating compositions may also contain one or more fillers. Examples of suitable fillers are aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. In the coating compositions of the invention, finely divided fillers are naturally preferred. The fillers may be used in the form of individual components. In practice, however, filler mixtures have been found to be particularly useful, for example calcium carbonate/kaolin, calcium carbonate/talc. Gloss paints generally comprise only small amounts of very finely divided fillers or do not comprise any fillers. Fillers also include flatting agents which significantly impair the gloss as desired. Flatting agents are generally transparent and may be either organic or inorganic. Examples of flatting agents are inorganic silicates, for example the Syloid® brands from W. R. Grace & Company and the Acematt® brands from Evonik GmbH. Organic flatting agents are obtainable, for example, from BYK-Chemie GmbH under the Ceraflour® brands and the Ceramat® brands, and from Deuteron GmbH under the Deuteron MK® brand.

The proportion of the pigments and fillers in the water-borne coating compositions can be described in a manner known per se via the pigment volume concentration (PVC). The PVC describes the ratio of the volume of pigments (VP) and fillers (VF) relative to the total volume, consisting of the volumes of binder (VB), pigments (VP) and fillers (VF) in a dried coating film in percent: PVC [%]=(VP+VF)×100/(VP+VF+VB).

If the water-borne coating compositions are formulated as a paint, they usually have a pigment volume concentration (PVC) of at least 5%, especially at least 10% and will typically not exceed 90%, in particular 85%. In a preferred group of embodiments, the PVC will not exceed a value of 60%, especially 50%, and is specifically in the range from 5 to 60% or 5 to 50%. However, the inventive effects of the polymer dispersions are also manifested in varnishes which typically have a pigment/filler content below 5% by weight, based on the varnish, and correspondingly have a PVC below 5%. In yet another group of embodiments, the PVC will be in the range of >60 to 90%, in particular in the range of 65 to 85%.

According to one group of embodiments, the water-borne coating compositions of the invention are designed as a paint containing white pigment—that is, they comprise at least one white pigment and optionally one or more fillers. As white pigment they include, in particular, titanium dioxide, preferably in the rutile form, optionally in combination with one or more fillers. With particular preference, the coating compositions of the invention comprise a white pigment, more particularly titanium dioxide, preferably in the rutile form, in combination with one or more fillers, such as chalk, talc or mixtures thereof, for example.

In another preferred group of embodiments, the water-borne coating compositions of the invention are designed as a clear-coat or as a wood-stain formulation. In contrast to paints, clear-coats are essentially devoid of pigments and fillers, while wood stains do not contain much fillers, i.e. they have a PVC of below 5%.

According to a particular group of embodiments, the present invention also relates to an waterborne coating composition (hereinafter also referred to as aqueous coating composition) comprising:
i) at least one aqueous polymer latex as defined above; and
ii) a titanium dioxide pigment.

According to a further particular group of embodiments, the present invention also relates to the use of the aqueous polymer latex as a binder in an aqueous coating composition containing a titanium dioxide pigment.

In the aforementioned embodiments the aqueous polymer latex is combined with a TiO₂ pigment slurry or paste. The TiO₂ concentration of an aqueous TiO₂ pigment slurry or paste used for preparing the aqueous coating composition will generally be in the range from 30% to 85% by weight, frequently 40% to 80% by weight and, based in each case on the total weight of the aqueous TiO₂ pigment slurry or paste. The titanium dioxide pigment used for preparing the aqueous dispersion of the pigment slurry or paste may be any TiO₂ pigment conventionally used in coating compositions, in particular in aqueous coating compositions. Frequently, a TiO₂ pigment is used wherein the TiO₂ particles are preferably in the rutile form. In another preferred embodiment the TiO₂ particles can also be coated e.g. with aluminum, silicon and zirconium compounds.

In general, the weight ratio of the polymer to the titanium dioxide pigment is in the range of ≥0.1:5.0 to ≤5.0:0.1; preferably the weight ratio of the polymer to the titanium dioxide pigment is in the range of ≥0.5:5.0 to ≤5.0:0.5; in particular more preferably the weight ratio of the polymer to the titanium dioxide pigment is in the range of ≥0.5:3.0 to ≤3.0:0.5 and in particular in the range of ≥0.5:1.5 to ≤1.5:0.5.

Preferably, the titanium dioxide pigment has an average primary particle size in the range of ≥0.1 μm to ≤0.5 μm, as determined by light scattering or by electron microscopy.

In general, the aqueous coating composition further comprises at least one additive selected from the group consisting of thickeners, defoamers, levelling agents, filming auxiliaries, biocides, wetting agents or dispersants, fillers and coalescing agents.

The aqueous coating composition can be simply prepared by mixing TiO₂ pigment powder or an aqueous slurry or paste of TiO₂ pigment with the aqueous polymer latex of the invention, preferably by applying shear to the mixture, e.g. by using a dissolver conventionally used for preparing water-borne paints. It will also be possible to prepare an aqueous slurry or paste of TiO₂ pigment and the aqueous polymer latex of the invention, which is then incorporated into or mixed with further polymer latex of the invention or with any other polymer latex binder.

The aqueous dispersion of the polymer composite may also be prepared by incorporating the aqueous polymer latex of the invention as a binder or co-binder in an aqueous base formulation of a paint, which already contains a TiO₂ pigment, e.g. by mixing the aqueous polymer latex of the invention with a pigment formulation that already contains further additives conventionally used in the paint formulation.

In order to stabilize the TiO₂ pigment particles in the aqueous pigment slurry or paste, the mixing may optionally be performed in the presence of additives conventionally used in aqueous pigment slurries or pigment pastes, such as dispersants. Suitable dispersants include but are not limited to, for example, polyphosphates such as sodium polyphosphates, potassium polyphosphates or ammonium polyphosphates, alkali metal salts and ammonium salts of acrylic acid homo- or copolymers or maleic anhydride polymers, polyphosphonates, such as sodium 1-hydroxyethane-1,1-diphosphonate, and naphthalenesulfonic salts, especially the sodium salts thereof.

The polymer concentration in the aqueous polymer latex used for preparing the aqueous dispersion of the polymer composite is generally in the range from 10% to 70% by weight, preferably 20% to 65% by weight and most preferably 30% to 60% by weight, based in each case on the total weight of the aqueous polymer latex.

In addition to the polymer latex of the present invention and a titanium dioxide pigment and an optional conventional binder, the aqueous coating compositions may contain one or more pigments different from the TiO₂ pigment and/or fillers as described above.

Preferably, the waterborne coating compositions comprise at least one aqueous polymer latex as defined herein, further comprises a rheology modifying agent. Suitable rheology modifying agents include associative thickener polymers and non-associative rheology modifiers. The aqueous liquid composition preferably comprises a thickening agent selected from the group consisting of associative thickeners and optionally a non-associative thickener.

Associative thickener polymers are well known and frequently described in the scientific literature, e.g. by E. J. Schaller et al., “Associative Thickeners” in Handbook of Coating Additives, Vol. 2 (Editor L. J. Calbo), Marcel Decker 192, pp. 105-164, J. Bieleman “PUR-Verdicker” in Additives for Coatings (Editor J. Bielemann), Wiley 2000, pp 50-58. NiSAT thickener polymers of the HEUR and HMPE type are also described in the patent literature, such as U.S. Pat. Nos. 4,079,028, 4,155,892, EP 61822, EP 307775, WO 96/31550, EP 612329, EP 1013264, EP 1541643, EP 1584331, EP 2184304, DE4137247, DE 102004008015, DE 102004031786, US 2011/0166291 and WO 2012/052508. Apart from that, associative thickener polymers are commercially available.

The associative thickener polymers include anionic, acrylate type thickener polymers, so-called HASE polymers (hydrophobically modified polyacrylate thickeners), which are copolymers of acrylic acid and alkyl acrylate monomers, where the alkyl group of the alkyl acrylate may have from 6 to 24 carbon atoms. The associative thickener polymers also include non-ionic associative thickeners, so called NiSAT thickeners (non-ionic synthetic associative thickeners), which usually are linear or branched block copolymers having at least one interior hydrophilic moiety, in particular a polyether moiety, especially at least one polyethylene oxide moiety and two or more terminal hydrocarbon groups each having at least 4 carbon atoms, in particular from 4 to 24 carbon atoms, e.g. a linear or branched alkyl radical having 4 to 24 carbon atoms or alkyl substituted phenyl having 7 to 24 carbon atoms. NiSAT thickeners include the hydrophobically modified polyethylene oxide urethane rheology modifiers, also termed HEUR or PUR thickeners, and hydrophobically modified polyethyleneoxides, which are also termed HMPE.

The amount of the associative thickener polymer will depend on the desired viscosity profile and is frequently in the range from 0.05 to 2.5% by weight, in particular 0.1 to 2% by weight of thickener, and especially 0.2 to 2% by weight, based on the latex paint.

Suitable non-associative rheology modifiers are in particular cellulose-based thickeners, especially hydroxyethyl cellulose, but also thickeners based on acrylate emulsions (ASE). Amongst the non-associative rheology modifiers preference is given to non-associative cellulose based thickeners.

The total amount of the thickener polymer will depend on the desired viscosity profile and is frequently in the range from 0.05 to 2.5% by weight, in particular 0.1 to 2% by weight of thickener, and especially 0.15 to 1.5% by weight, based on the latex paint.

The aqueous coating compositions of the invention may also comprise customary auxiliaries. The customary auxiliaries will depend from the kind of the coating in a well-known manner and include but are not limited to:
wetting agents or dispersants,
filming auxiliaries, also termed coalescents,
leveling agents,
UV stabilizers,
biocides and
defoamers/de-aerators.

Suitable wetting agents or dispersants are, for example, sodium polyphosphates, potassium polyphosphates or ammonium polyphosphates, alkali metal salts and ammonium salts of acrylic acid copolymers or maleic anhydride copolymers, polyphosphonates, such as sodium 1-hydroxyethane-1,1-diphosphonate, and naphthalenesulfonic salts, especially the sodium salts thereof.

Suitable filming auxiliaries are solvents and plasticizers. Plasticizers, in contrast to solvents, have a low volatility and preferably have a boiling point at 1013 mbar of higher than 250° C., while solvents have a higher volatility than plasticizers and preferably have a boiling point at 1013 mbar of less than 250° C. Suitable filming auxiliaries are, for example, white spirit, pine oil, propylene glycol, ethylene glycol, butyl glycol, butyl glycol acetate, butyl glycol diacetate, butyl diglycol, butylcarbitol, 1-methoxy-2-propanol, 2,2,2-trimethyl-1,3-pentanediol monoisobutyrate (Texanol®) and the glycol ethers and esters, commercially available, for example, from BASF SE under the Solvenon® and Lusolvan® and Loxanol® names, and from Dow under the Dowanol® trade name. The amount is preferably <5% by weight and more preferably <1% by weight, based on the overall formulation. Formulation is also possible completely without filming auxiliaries. If the coating compositions contain filming auxiliaries, these are preferably selected from plasticizers. Frequently, the coating compositions do not require any filming auxiliaries.

Further suitable auxiliaries and components are e.g. described by J. Bieleman in “Additives for Coatings”, Whiley-VCH, Weinheim 2000; by T. C. Patton in “Paint Flow and Pigment Dispersions”, 2nd Edition, John Whiley & Sons 1978; and by M. Schwartz and R. Baumstark in “Water based Acrylates for Decorative Coatings”, Curt R. Vincentz Verlag, Hanover 2001.

The waterborne coating compositions of the invention may also be formulated as a low VOC paint. In this case the concentration of volatile compounds in the coating composition is preferably below 0.1 wt.-%, more preferably below 0.05 wt.-%, based on the total amount of the waterborne coating composition. A volatile compound in terms of the invention is a compound, which has a boiling point at 1013 mbar of less than 250° C.

The waterborne coating compositions of the invention are particularly useful for coating a wooden substrate such as wood or wood-based materials. The waterborne coating compositions of the invention are particularly useful in architectural coatings, i.e. for coating exterior or interior parts of a building. In this case, the substrate may be a mineral substrate, such as plaster, gypsum, plasterboard or concrete, wood, wood-based materials, metal, wallpaper or plastic, such as PVC.

The waterborne coating compositions can be applied to substrates to be coated in a customary manner, for example by applying it with brushes or rollers, by spraying, by dipping, by rolling, or by bar coating to the desired substrate. Preferred applications are by brush and/or by roller.

Usually, the coating of substrates is effected in such a way that the substrate is first coated a waterborne coating composition of the invention, and then the thus obtained aqueous coating is subjected to a drying step, especially within the temperature range of ≥−10 and ≤+50° C., advantageously ≥+5 and ≤+40° C. and especially advantageously ≥+10 and ≤+35° C.

The substrates coated with a waterborne coating composition of the invention have excellent resistance to whitening on exposure to water or to weathering conditions. Moreover, the coatings have high blocking resistance, when containing two or more polymer phases. Yet, the coatings obtained according by using a coating composition of the invention are less prone to form cracks which are often observed when coating wooden substrates with waterborne coating compositions. Moreover, they are stable against aging and do not suffer from an undesirable increase of viscosity upon storage.

The invention is to be illustrated by non-limiting examples which follow.

### 1. ABBREVIATIONS

ADDH: adipic acid dihydazide
AM: acrylamide
AMA: allyl methacrylate
AS: acrylic acid
DAAM: diacetone acrylamide
DLS D[v, 4.3] value as determined by dynamic light scattering
EHA: 2-ethylhexyl acrylate
area % area percentage
FuselA: fusel-alcohol acrylate
i-BuA: isobutyl acrylate
MAS: methacrylic acid
MMA: methyl methacrylate
MeHQ 4-methoxyphenol (hydroquinone monomethylether)
MEMO: 3-methacryloxypropyl trimethoxysilane
n-BuA: n-butyl acrylate
pphm: parts per 100 monomers
PVC pigment/volume concentration
PTZ phenothiazine
RH: relative humidity
RT: room temperature (22-23° C.)
rpm: revolutions per minute
S: styrene
SC: solids content
UMA: 25% solution of of imidazolin-2-on-1-yl-ethyl methacrylate in methyl methacrylate
wt %: % by weight

Here and in the following the terms “room temperature” and “ambient temperature” means a temperature in the range of 22-23° C.

### 2. ANALYTICS OF THE POLYMER LATEXES

### 2.1 Solids Content

The solids content was determined by drying a defined amount of the aqueous polymer dispersion (about 2 g) to constant weight in an aluminum crucible having an internal diameter of about 5 cm at 130° C. in a drying cabinet (2 hours). Two separate measurements were conducted. The value reported in the example is the mean of the two measurements.

### 2.2 Particle Diameter

If not stated otherwise, average particle diameter of the polymer latex was determined by dynamic light scattering (DLS) as described above, using a Malvern HPPS.

The weight-average particle diameter of the polymer latex may also be determined by HDC. Measurements were carried out using a PL-PSDA particle size distribution analyzer (Polymer Laboratories, Inc.). A small amount of sample of the polymer latex was injected into an aqueous eluent containing an emulsifier, resulting in a concentration of approximately 0.5 g/l. The mixture was pumped through a glass capillary tube of approximately 15 mm diameter packed with polystyrene spheres. As determined by their hydrodynamic diameter, smaller particles can sterically access regions of slower flow in capillaries, such that on average the smaller particles experience slower elution flow. The fractionation was finally monitored using an UV-detector which measured the extinction at a fixed wavelength of 254 nm.

### 2.3 Brookfield Viscosity

Viscosity was measured at 20° C. according to the standard method DIN EN ISO 3219:1994 using a “Brookfield RV”-type laboratory viscosimeter employing spindles #4 or #5 at 100 revolutions per minute.

### 2.4 Glass Transition Temperature Tg

The glass transition temperature was determined by the DSC method (Differential Scanning Calorimetry, 20 K/min, midpoint measurement, DIN 53765:1994-03) by means of a DSC instrument (Q 2000 series from TA instruments).

### 3. EMULSIFIERS, MONOMERS, SEEDLATEX

Emulsifier 1: 45% b.w. aqueous solution of the sodium salt of a C12-Alkyldiphenyloxide disulfonate (Dowfax® 2A1)
Emulsifier 2: 20% by weight aqueous solution of a ethoxylated C16/C18 alkanol with 18 EO (Lutensol® AT 18)
Emulsifier 3: 27% by weight aqueous solution of a sodium lauryl ether sulfate (Disponil® FES 27)
Emulsifier 4: 15% by weight aqueous solution of sodium dodecyl sulfate (Disponil® SDS 15)
Emulsifier 5: 25 wt % aqueous solution of the sodium salt of a sulphated ethoxylated alkyl glyceryl allyl ether of the formula (III), degree of ethoxylation=10 (Adeka Reasoap SR-1025)
Emulsifier 6: 20% by weight aqueous solution of a ethoxylated iso C13 alkanol with 8 EO (Lutensol T082)
Seed latex 1: polyacrylate latex having a solids content of 33.00% by weight and a D[v, 4.3] value of 30 nm
Seed latex 2: polystyrene latex having a solids content of 33.00% by weight and a D[v, 4.3] value of 30 nm
Sulfinate Sodium hydroxymethanesulfinate (Rongalit® C) ureidoethyl methacrylate (UMA): 25 wt % solution of imidazolin-2-on-1-yl-ethyl methacrylate in methyl methacrylate
Sipomer® PAM 100: phosphate hemiester of hydroxyethyl methacrylate isobutyl acrylate: isobutyl acrylate having 57% of bio-carbon, obtained from BCH Bruhl-Chemikalien Handel GmbH
isoamyl acrylate see protocol below
bio isoamyl acrylate mixture of 2-methylbutyl acrylate and 3-methylbutyl acrylate in a weight ratio of 1:4—see protocol below
fusel-oil acrylate: synthesized via esterification of acrylic acid with fusel-oil alcohols (purified by distillation), having 63% bio-carbon; contains approx. 87% (iso)amyl acrylate (mixture of 2-methyl and 3-methyl-butyl isomers)+10% isobutyl acrylate—production see protocol below

Protocol for Producing Fusel-Oil Acrylate:

464 g of fusel alcohol obtained as a side stream of the production of bio ethanol (containing 10.5 wt % water and 89.5 wt % of an organic portion consisting of 12.4 area % isobutanol and 80.0 area % of a mixture of 2-methylbutanol and 3-methylbutanol), 400 mL of cyclohexane, 4.5 g of a stabilizer solution consisting of 3.33 wt % of MeHQ and 8.33 wt % of a 50 wt % hypophosphorous acid, and 3.5 g of a 5 wt % solution of copper(II) acetate were charged into a 2 L four-necked flask equipped with a crescent stirrer, a water separator with an intensive condenser, a gas feed-in tube, and a thermometer. 377.5 g of glacial acrylic acid (stabilized with 200 ppm of MeHQ) and 28.5 g of p-toluenesulfonic acid monohydrate were added. The water separator was filled with cyclohexane.

The reaction mixture was then heated. At a bath temperature of 110° C., water was separated while introducing air. 160 g of water were distilled off. After a reaction time of 5.5 h, the mixture was cooled down. 400 mL of water were added to the reaction mixture at an internal temperature of 50° C.

After separation of the aqueous phase, a mixture of 375 mL water and 150 mL of a 12.5 wt % aqueous NaOH was added. After separation of the aqueous phase, the organic phase was rinsed with 500 mL of a 15 wt % aqueous NaCl solution. 877 g of a crude solution were obtained to which 0.9 g of phenothiazine was added, and the solution was concentrated by means of a rotary evaporator at 60° C. and 100 mbar to 65 mbar. Then, at a bath temperature of 70° C. and a pressure of 20 mbar, the product was distilled off. 491.2 g of fusel oil acrylate were obtained, which were stabilized with 100 mg of MeHQ. The product was clear and colorless and was analyzed by means of gas chromatography. It contained 11.5 area % isobutyl acrylate and 84.0 area % of a mixture of 2-methyl butyl acrylate and 3-methyl butyl acrylate in a 20:80 ratio as determined via ¹H NMR.

Protocol for Producing Isoamyl Acrylate:

1058 g of isoamyl alcohol (petrochemical source), 823 g of cyclohexane, 11.4 g of a stabilizer solution consisting of 3.33 wt % of MeHQ and 8.33 wt % of a 50 wt % hypophosphorous acid, and 8.4 g of a 5 wt % copper(II) acetate solution were put in a heatable 4L double-walled glass reactor equipped with a thermal sensor, anchor stirrer, water separator, intensive condenser, and air feed-in. Then 951 g of glacial acrylic acid (stabilized with 200 ppm MeHQ) were added. 95.4 g of a 65% p-toluenesulfonic acid were added and heating was performed. Water destilled at a bottom temperature of 82 to 101° C.

278 mL of water with a water content of 95.5% were separated. After 5.5 h, the reaction was stopped. After cooling, the reaction mixture was extracted first with 700 mL of water, then with a mixture of 500 mL of water and 400 g of a 12.5% NaOH solution, and then again with 800 mL of water, and the aqueous phases were separated in each case. After the last phase separation, 1 g of MeHQ was added to the organic phase which then was fractionally distilled at a pressure of 230 to 50 mbar. The internal temperature increased from 44 to 81° C. 1532 g of isoamyl acrylate, still containing 0.18 area % isoamyl alcohol, were obtained with a GC purity of 99.1 area % and a color number of 5 Hazen and stabilized with 100 ppm of MeHQ.

Protocol for Producing Bio Isoamyl Acrylate:

Ethyl acrylate (2555 g), MeHQ (3.6 g), phenothiazine (1.5 g) as well as 1000 g of isoamyl alcohol obtained by fractional distillation of a side stream of the production of bio ethanol (mixture of 2-methylbutanol and 3-methylbutanol in a ratio of 1:4, determined via 1H NMR) were introduced and heated up under lean air feed-in and stirring in a heatable 4L double-walled glass reactor with heatable lid, equipped with 3-stage cross blade stirrer, 50 cm column (Montz A3-750 packing), cooler, phase separator, thermal sensor as well as gas inlet tube. At an internal temperature of 70° C., titanium tetraisopropoxide (36.06 g) was added.

After boiling had started, take-off of was started with a reflux ratio of 5:1 (R: D). Ethyl acrylate was fed into the bottom in portions during the first 4 h in amounts corresponding to the distillate. Within 4 h, 111 g of a solution of PTZ in ethanol (0.01 wt %) were dosed onto the top of the column. Bottom samples were taken at regular intervals and analyzed by means of gas chromatography to monitor the progress of the reaction. Over the next 6 h, the pressure was gradually reduced to 550 mbar and the reflux ratio was gradually adjusted to 2:5 (R: D). At a conversion of >99%, fractional distillation of first ethyl acrylate and then the desired product was started. The pressure was further reduced to 80 mbar. Fractions having a purity of >98% were combined. 1272 g of bio-isoamyl acrylate (1:4 mixture of 2-methylbutyl acrylate and 3-methylbutyl acrylate) with a purity of 99.2% were obtained. The product was stabilized with 100 ppm of MeHQ.

### 4. PREPARATION EXAMPLES

### 4.1 Comparative Examples C1 to C2 and Inventive Examples D1 to D4

Emulsion A was prepared by mixing 345 g of water, 8.2 g of acrylic acid, 18.9 g of acrylamide, 8.7 g of emulsifier 1, 12.6 g of emulsifier 2, and the respective amount of monomers given in table 1.

An initiator solution I was prepared by dissolving 0.9 g of sodium peroxodisulfate in 12.7 g of deionized water.

An oxidation solution O was prepared by dissolving 0.5 g of t-butyl hydroperoxide in 5 g of deionized water.

A reduction solution R was prepared by dissolving 0.9 g of sodium sulfite in 7 g of deionized water mixed with 0.4 g of acetone.

A reaction vessel, equipped with a stirrer and three separate feeding lines, was charged with 182 g of deionized water and 17 g of emulsifier 4 and the vessel was pre-heated to 95° C. After having reached the temperature of 95° C. 3.3% of emulsion A was fed into the vessel together with 25% of initiator solution I and the mixture was stirred for 10 minutes at 95° C. Thereafter, the remainder of the emulsion A was fed into the reaction vessel in the course of 120 minutes while maintaining 95° C. Starting at the same time as Emulsion A the remainder of the initiator solution I was fed via a separate feed line into the reaction vessel in the course of 120 minutes. After completion of the addition of emulsion A and initiator solution I the stirring was continued for an additional 15 minutes at 95° C. Afterwards the vessel was cooled to 90° C. and 2.7 g of ammonia (25% wt_{aq}) diluted with 4.0 g of water were added to the vessel. Thereafter, oxidation solution O and reduction solution R were fed in parallel via separate feed lines into the reaction vessel in the course of 60 minutes. After having completed the addition of oxidation solution and reduction solution, the vessel was cooled to room temperature and 2.4 g of ammonia (25% wt_{aq}) diluted with 15 g of water were added.

### 4.2 Comparative Example C3 and Inventive Examples D5 and D6

Emulsion A was prepared by mixing 265 g of water, 13 g of acrylic acid, 13 g of acrylamide, 16 g of emulsifier 3, 7 g of emulsifier 2, and the respective amount of monomers given in table 1.

Initiator solution I was prepared by dissolving 7.65 g of sodium peroxodisulfate in 101.57 g of deionized water.

Oxidation solution O was prepared by dissolving 2.52 g of t-butyl hydroperoxide in 22.67 g of deionized water.

Reduction solution R was prepared by dissolving 1.44 g of sodium sulfite in 15.36 g of deionized water mixed with 0.85 g of acetone.

A reaction vessel, equipped with a stirrer and three separate feed lines, was charged with 265 g of deionized water and 30 g of seed latex 1, and the mixture was pre-heated to 83° C. Having reached the temperature of 83° C., emulsion A was fed into the reaction vessel in the course of 120 minutes, while maintaining a temperature of 83° C. Starting at the same time as emulsion A the remainder of the initiator solution I was fed via a separate feed line into the reaction vessel in the course of 120 minutes. Having completed the addition of emulsion A and the initiator solution, the reaction mixture was stirred for an additional 20 minutes at 83° C.

Thereafter, oxidation solution O and reduction solution R were fed in parallel via separate feed lines into the reaction vessel in the course of 60 minutes at 83° C. After having completed the addition of oxidation solution and reduction solution, the vessel was cooled to room temperature and 3 g of aqueous ammonia (25%) and 15 g of water were added.

TABLE 1

| Monomer | C1 | D1 | D2 | C2 | D3 | D4 | C3 | D5 | D6 |
|---|---|---|---|---|---|---|---|---|---|
| MMA [g] | 464.3 | 382.0 | 285.5 | 465.4 | 362.9 | 430.0 | 257.4 | 222.9 | 140.3 |
| n-BuA [g] | 0 | 0 | 0 | 396.3 | 0 | 0 | 445.4 | 233.5 | 0 |
| EHA [g] | 397.5 | 213.2 | 0 | 0 | 0 | 0 | 0 | 0 | 0 |
| S [g] | 0 | 0 | 0 | 0 | 0 | 0 | 141.0 | 141.0 | 144.3 |
| i-BuA [g] | 0 | 266.5 | 576.3 | 0 | 498.9 | 0 | 0 | 264.4 | 577.2 |
| FuselA [g] | 0 | 0 | 0 | 0 | 0 | 431.8 | 0 | 0 | 0 |
| SC [wt %] | 48.5 | 48.1 | 47.9 | 49.8 | 49.9 | 48.6 | 52.8 | 52.7 | 52.8 |
| pH | 8.5 | 8.6 | 8.7 | 9.6 | 9.4 | 7.2 | 7.6 | 7.4 | 7.2 |
| DLS [nm] | 85 | 85 | 82 | 107 | 110 | 98 | 131 | 129 | 130 |
| Tg(Fox) [° C.] | 11 | 10 | 12 | 23 | 22 | 23 | 16 | 15 | 16 |
| % C(bio) [calc.] 1) | 0% | 18% | 39% | 0% | 34% | 32% | 0% | 17% | 36% |
| % C(bio) [meas.] 2) | n.d. | 18% | 38% | 0% | 34% | 32% | n.d. | n.d. | n.d. |

1) Theoretical relative amount of bio carbon in the polymer latex, as calculated from the reported amount of bio carbon in isobutanol (value can be experimentally determined by the ¹²C/¹⁴C ratio via mass spectrometry).
2) Measured relative amount of bio carbon in the polymer latex, as determined in accordance to ASTM D6866-18 (method B); measurement performed at the Curt-Engelhorn Center for Archaeometry (Mannheim, Germany)

### 4.3 Comparative Example C4

A polymerization vessel equipped with metering devices and temperature regulation was charged at 20 to 25° C. (room temperature) under a nitrogen atmosphere with 586.0 g of deionized water, 13.2 g of emulsifier 5 and 20.8 g of a 3 wt % aqueous tetrasodium pyrophosphate solution. This initial charge was heated to 80° C. with stirring. When this temperature had been reached, a homogenous solution of 3.0 g sodium persulfate in 39.9 g deionized water was added and stirring took place for 2 minutes at 80° C. Thereafter, emulsion feed 1 was commenced and was metered in over the course of 45 minutes while maintaining a temperature of 80° C. After completion of emulsion feed 1, polymerization was continued for 10 minutes at 80° C.

Then 26.9 g of a 25 wt % aqueous ammonia solution (amount needed for complete neutralization of methacrylic acid from emulsion feed 1) and 3.7 g deionized water was added and stirred in for 10 minutes.

Emulsion Feed 1 (Homogeneous Mixture of):
139.7 g of deionized water
4.4 g of emulsifier 5
34.0 g of methacrylic acid
27.2 g of ureidoethyl methacrylate
210.8 g of methyl methacrylate
34.0 g of n-butyl acrylate
170.0 g of a 20 wt % strength aqueous solution of diacetoneacrylamide and
15.7 g of 2-ethylhexyl thioglycolate

Subsequently emulsion feed 2 was commenced. When 50% of this feed had been metered in over 45 minutes, a homogenous solution of 0.5 g sodium persulfate in 6.6 g deionized water was metered in in parallel over the course of another 45 minutes; total feed time for emulsion feed 2 was 90 minutes.

Emulsion Feed 2 (Homogeneous Mixture of):
188.4 g of deionized water
7.6 g of emulsifier 5
198.0 g of n-butyl acrylate
224.4 g of 2-ethylhexyl acrylate and
237.6 g of methyl methacrylate

After having completed emulsion feed 2, the polymerization mixture was left to react further at 80° C. for 30 minutes with stirring. Then 130.8 g of deionized water were added and stirring was continued at 70° C. for another 90 minutes. The aqueous polymer dispersion obtained was then cooled to room temperature. At room temperature, 141.7 g of a 12 wt % strength aqueous solution of adipic dihydrazide were added. Finally, the dispersion was filtered through a 125 μm filter.

The resulting aqueous polymer dispersion had a solids content of 42.9 wt %. On dilution with deionized water, the aqueous polymer dispersion has a weight-average particle diameter of 37 nm (measured by means of HDC).

### 4.4 Inventive Examples D7 to D14

The polymer latexes of inventive examples D7 to D14 were prepared by analogy to the protocol of example D4 replacing the monomers in feeds 1 and 2 by the respective relative amounts given pphm and summarized in table 2.

TABLE 2

| | | | | | | | | |
|---|---|---|---|---|---|---|---|---|
| C4 | D7 | D8 | D9 | D10 | D11 | D12 | D13 | D14 |

Feed 1

| | | | | | | | | | |
|---|---|---|---|---|---|---|---|---|---|
| nBuA | 3.4 | 3.4 | 3.4 | 3.4 | 3.4 | 0 | 0 | 0 | 0 |
| i-BuA | 0 | 0 | 0 | 0 | 0 | 4.1 | 4.1 | 4.1 | 4.1 |
| MMA | 21.1 | 21.1 | 21.1 | 21.1 | 21.1 | 20.4 | 20.4 | 20.4 | 20.4 |
| MAS | 3.4 | 3.4 | 3.4 | 3.4 | 3.4 | 3.4 | 3.4 | 3.4 | 3.4 |
| DAAM | 3.4 | 3.4 | 3.4 | 3.4 | 3.4 | 3.4 | 3.4 | 3.4 | 3.4 |
| UMA | 2.7 | 2.7 | 2.7 | 2.7 | 2.7 | 2.7 | 2.7 | 2.7 | 2.7 |
| Tg(Fox) | 91 | 91 | 91 | 91 | 91 | 92 | 92 | 92 | 92 |
| [° C.] | | | | | | | | | |

Feed 2

| | | | | | | | | | |
|---|---|---|---|---|---|---|---|---|---|
| EHA | 22.5 | 19.1 | 16.5 | 2.6 | 7.9 | 19.1 | 16.5 | 2.6 | 7.9 |
| nBuA | 19.5 | 0 | 0 | 0 | 0 | 0 | 0 | 0 | 0 |
| i-BuA | 0 | 29.2 | 31.2 | 54.4 | 46.4 | 29.2 | 31.2 | 45.4 | 46.4 |
| n-BMA | 0 | 0 | 3.3 | 17.5 | 0 | 0 | 3.3 | 17.5 | 0 |
| S | 0 | 0 | 0 | 0 | 6.6 | 0 | 0 | 0 | 6.6 |
| MMA | 23.5 | 17.2 | 14.5 | 0 | 4.6 | 17.2 | 14.5 | 9 | 4.6 |
| AMA | 0.5 | 0.5 | 0.5 | 0.5 | 0.5 | 0.5 | 0.5 | 0.5 | 0.5 |
| Tg(Fox) | −10 | −10 | −9 | −11 | −11 | −10 | −9 | −11 | −11 |
| [° C.] | | | | | | | | | |

Polymer Latex

| | | | | | | | | | |
|---|---|---|---|---|---|---|---|---|---|
| SC [wt %] | 42.9 | 42.5 | 42.1 | 42.8 | 42.4 | 42.7 | 42.5 | 42.4 | 42.2 |
| HDC [nm] | 37 | 35 | 36 | 40 | 41 | 48 | 45 | 51 | 52 |
| pH | 7.9 | 8.1 | 8.2 | 8.1 | 8.1 | 8.2 | 8.2 | 8.1 | 8.1 |
| BF¹⁾ | 664 | 612 | 512 | 500 | 384 | 804 | 568 | 460 | 432 |
| [mPas] | | | | | | | | | |
| bio-C²⁾ | 0 | 17 | 18 | 27 | 27 | 20 | 21 | 29 | 29 |
| [%] | | | | | | | | | |

¹⁾Brookfield viscosity
²⁾bio-C: Theoretical relative amount of bio carbon in the polymer latex (value can be experimentally determined by the ¹²C/¹⁴C ratio via mass spectrometry)

### 4.5 Comparative Example C5

In a polymerization vessel equipped with metering devices and a temperature control at 22° C.,
341.9 g Deionized water and
55.0 g Emulsifier 4
were added in a nitrogen atmosphere and heated to 87° C., whilst being stirred. At 80° C., 43.0 g of feed 2 and 3.2 g of a 7% b.w. aqueous solution of sodium peroxodisulfate were added, and the mixture was further heated to 87° C. 5 minutes later, feed 1 and 2 (remaining quantity) were started and metered into the reaction vessel within 120 minutes. After the end of feed 1 and 2, postpolymerization was effected for 5 minutes. Then, feed 3 and 4 were metered into the reaction vessel in 45 minutes.

Feed 1:
13.7 g 7% b.w. aqueous solution of sodium peroxodisulfate

Feed 2 (Emulsion Comprising):
526.1 g Deionized water
36.7 g Emulsifier 4
8.0 g Acrylic acid
9.0 g 50% b.w. aqueous solution of acrylamide
313.0 g Methyl methacrylate
448.7 g 2-Ethylhexyl acrylate
42.5 g 25% b.w. solution of ureido methacrylate in methyl methacrylate

Feed 3:
5.1 g 7% b.w. aqueous solution of sodium peroxodisulfate
Feed 4 (emulsion comprising):
272.9 g Deionized water
13.9 g Emulsifier 4
8.0 g Acrylic acid
42.5 g 25% b.w. solution of ureido methacrylate in methyl methacrylate
232.9 g Methyl methacrylate

After completion of feed 3 and 4, the polymerization mixture was allowed to react for 30 minutes at 87° C.; then 5.3 g of a 25% b.w. aqueous solution of ammonia and 55.4 g of deionized water were added. The mixture was cooled down to 82° C. and stirred for 60 minutes. At the same time, 22.9 g of a 7.7% b.w. aqueous solution of hydrogen peroxide and 22.8 g of a 6.8% b.w. aqueous solution of L-Ascorbic acid were metered into the reaction vessel. After that, 15.4 g of a 7.1% b.w. aqueous ammonia solution were added; the mixture was cooled down to 22° C. and the aqueous polymer dispersion was filtered via a 125 μm filter.

The obtained polymer latex had a solids content of 44.2%, a pH-value of 7.7 and an average particle size of 68 nm according to HOC.

### 4.6 Inventive Examples 015 to 022

The polymer latexes of inventive examples 015 to 022 were prepared by analogy to the protocol of example 05 replacing the monomers by the respective relative amounts given pphm and summarized in table 3.

TABLE 3

| | | | | | | | | |
|---|---|---|---|---|---|---|---|---|
| C5 | D15 | D16 | D17 | D18 | D19 | D20 | D21 | D22 |

Feed 1

| | | | | | | | | | |
|---|---|---|---|---|---|---|---|---|---|
| EHA | 40.8 | 0 | 25 | 0 | 0 | 3.5 | 5.0 | 0 | 0 |
| i-BuA | 0 | 63.5 | 25.0 | 60.0 | 57.5 | 55.0 | 50.0 | 0 | 0 |
| FuselA | | | | | | | | 49.5 | 60.0 |
| MMA | 28.5 | 5.9 | 19.4 | 9.4 | 11.9 | 10.9 | 14.4 | 19.9 | 9.4 |
| UMA | 3.9 | 3.9 | 3.9 | 3.9 | 3.9 | 3.9 | 3.9 | 3.9 | 3.9 |
| AS | 0.7 | 0.6 | 0.6 | 0.6 | 0.6 | 0.6 | 0.6 | 0.6 | 0.6 |
| AM | 0.4 | 0.4 | 0.4 | 0.4 | 0.4 | 0.4 | 0.4 | 0.4 | 0.4 |
| Tg(Fox) [° C.] | −4 | −9 | −6 | −4 | −1 | −4 | 0 | −3 | −20 |

Feed 2

| | | | | | | | | | |
|---|---|---|---|---|---|---|---|---|---|
| MMA | 21.2 | 24.9 | 24.9 | 24.9 | 24.9 | 24.9 | 24.9 | 24.9 | 24.9 |
| UMA | 3.9 | 0 | 0 | 0 | 0 | 0 | 0 | 0 | 0 |
| AS | 0.7 | 0.9 | 0.9 | 0.9 | 0.9 | 0.9 | 0.9 | 0.9 | 0.9 |
| Tg(Fox) [° C.] | 114 | 119 | 119 | 119 | 119 | 119 | 119 | 119 | 119 |

Polymer Latex

| | | | | | | | | | |
|---|---|---|---|---|---|---|---|---|---|
| SC | 44.2 | 44.2 | 44.2 | 44.8 | 44.3 | 45.0 | 44.8 | 44.2 | 44.7 |
| [wt %] | | | | | | | | | |
| HDC | 68 | 74 | 77 | 77 | 77 | 74 | 77 | 77 | 77 |
| [nm] | | | | | | | | | |
| pH | 7.7 | 8.4 | 8.3 | 8.1 | 8.2 | 8.2 | 8.3 | 8.4 | 8.3 |
| BF¹⁾ [mPas] | 260 | 300 | 270 | 300 | 270 | 304 | 230 | 280 | 272 |
| bio-C²⁾ [%] | 0 | 38 | 15 | 36 | 34 | 33 | 30 | 33% | 39% |
| % C-bio [meas.]³⁾ | 1% | n.d. | n.d. | 37% | n.d. | n.d. | n.d. | 34% | 40% |

¹⁾BF: Brookfield viscosity at 20° C.
²⁾bio-C: Theoretical relative amount of bio carbon in the polymer latex (value can be experimentally determined by the ¹²C/¹⁴C ratio via mass spectrometry)
³⁾% C-bio [meas.]: Measured relative amount of bio carbon in the polymer latex, as determined in accordance to ASTM D6866-18 (method B).

### 4.6 Comparative Example C6

A polymerization vessel equipped with metering devices and temperature regulation was charged at room temperature under a nitrogen atmosphere with 145.9 g of deionized water and 0.8 g of 33 wt. % polystyrene seed-latex 2. This initial charge was heated to 85° C. with stirring. When this temperature had been reached, 7.1 g of a 7 wt. % solution of sodium persulfate in deionized water was added and stirring took place for 5 minutes at 85° C.

Thereafter emulsion feed 1 was commenced and was metered in over the course of 113 minutes while maintaining a temperature of 85° C. Starting at the same time, 21.4 g of a 7 wt. % solution of sodium persulfate in deionized water was added to the polymerization vessel within a timeframe of 180 minutes.

Emulsion Feed 1 (Homogeneous Mixture of):
155.0 g of deionized water
13.4 g of emulsifier 3
149.1 g of n-butyl acrylate
59.0 g of 2-ethylhexyl acrylate
166.0 g of styrene, and
1.0 g of MEMO

Directly after having fed emulsion feed 1, emulsion feed 2 was commenced and was metered in over the course of 37 minutes.

Emulsion Feed 2 (Homogeneous Mixture of):
52.5 g of deionized water
4.5 g of emulsifier 3
5.0 g of Sipomer® PAM 100
49.7 g of n-butyl acrylate
19.6 g of 2-ethylhexyl acrylate, and
50.6 g of styrene

After having completed emulsion feed 2, 6.1 g deionized water was added and the polymerization mixture was left to react further at 85° C. for 30 minutes with stirring. After partial neutralization with 0.8 g of 25 wt. % aqueous ammonia 16.3 g of deionized water were added and stirring was continued at 85° C. for another 5 minutes. Subsequently, 15.0 g of a 10 wt. % aqueous tert-butyl hydroperoxide solution and 12.2 g of a 13 wt. % aqueous acetone bisulfite solution was metered in in parallel over the course of 120 minutes. 90 minutes after having started this chemical deodorization step, 14.5 g of a 10 wt. % solution of sodium hydroxide in deionized water was added to the mixture within 30 minutes. The aqueous polymer dispersion obtained was then cooled to room temperature and another 15.8 g of rinsing water was added. Finally, the dispersion was filtered through a 125 μm filter.

The resulting aqueous polymer dispersion had a solids content of 51.7 wt %. On dilution with deionized water, the aqueous polymer dispersion has a weight-average particle diameter of 338 nm (measured by means of HDC).

### 4.7 Inventive Example D23

The polymer latex of inventive example D23 was prepared by analogy to the protocol of example C6 replacing the monomers by the respective relative amounts given pphm and summarized in table 4.

TABLE 4

| Monomer | C6 | D23 |
|---|---|---|
| n-BuA [g] | 198.8 | 0 |
| EHA [g] | 78.6 | 0 |
| S [g] | 216.6 | 139.3 |
| i-BuA [g] | 0 | 354.8 |
| SC [wt %] | 51.7 | 51.3 |
| pH | 7.6 | 7.4 |
| DLS [nm] | 335 | 319 |
| Tg(Fox) [° C.] | 3 | 5 |
| Monomer | C6 | D23 |
| bio-C¹⁾ [%] | 0% | 37% |

¹⁾bio-C: Theoretical relative amount of bio carbon in the polymer latex (value can be experimentally determined by the ¹²C/¹⁴C ratio via mass spectrometry)

### 4.8 Inventive Example D24

A reactor equipped with stirrer, temperature control, nitrogen inlet and several injection possibilities was charged with 855 g deionized water, 95.5 g of seed latex 2. The reaction mixture was purged with nitrogen and heated to 85° C. At 85° C. 17.3 g of feed 2 were added. After 5 min, feed 1 and feed 2 were added in 180 min. Feed 1: 1345.2 g deionized water, 64.7 g emulsifier 1, 72.8 g emulsifier 6, 24.3 g acrylic acid, 48.5 g of a 50 wt % aqueous solution of acrylamide, 1425.9 g isobutyl acrylate, 950.6 g methyl methacrylate. Feed 2: 69.3 g aqueous sodium persulfate solution (7 wt %). The reaction mixture was post-polymerized at 85° C. for 30 min. Then feed 3 and feed 4 were added in 60 min. Feed 3: 24.3 g aqueous t-butylhydroperoxide solution (10 wt %). Feed 4: 21.8 g aqueous sulfinate solution (10 wt %). Then the reaction mixture was cooled down to ambient temperature and neutralized with aqueous sodium hydroxide to pH 8-9.

Tg (dried dispersion): 21° C.

Average particle diameter (DLS): 130 nm

Solid contents: 46.1 wt %

### 4.9 Comparative Example C7

A reactor equipped with stirrer, temperature control, nitrogen inlet and several injection possibilities was charged with 855 g deionized water, 95.5 g seed latex 2. The reaction mixture was purged with nitrogen and heated to 85° C. At 85° C. 17.3 g of feed 2 were added. After 5 min, feed 1 and feed 2 were added in 180 min. Feed 1: 1345.2 g deionized water, 64.7 g emulsifier 1, 72.8 g emulsifier 6, 24.3 g acrylic acid, 48.5 g acrylamide (50 wt % aqueous solution), 1261.0 g butyl acrylate, 1115.5 g methyl methacrylate. Feed 2: 69.3 g aqueous sodium persulfate solution (7 wt %). The reaction mixture was post-polymerized at 85° C. for 30 min. Then feed 3 and feed 4 were added in 60 min. Feed 3: 24.3 g aqueous t-butylhydroperoxide solution (10 wt %). Feed 4: 21.8 g aqueous sulfinate solution (10 wt %). Then the reaction mixture was cooled down to ambient temperature and neutralized with aqueous sodium hydroxide to pH 8-9.

Tg (dried dispersion): 20° C.

Average particle diameter (DLS): 127 nm

Solid contents: 47.9 wt %

### 5. APPLICATION PROPERTIES OF THE POLYMER LATEX

### 5.1 Water Uptake

The polymer latex was diluted to 25 wt %. Then, the latex was cast onto a rubber plate (6.7*14.9 cm) to obtain a clear film with a thickness of approx. 750 μm after drying. This film was placed on a frame with gauze for 7 days to dry completely. Then 2 pieces of film (2*2 cm) were cut out and weighed. Then, the film pieces were stored separately in 100 ml glass bottles in deionized water for 24 hours (w_{dry}). Then, they are taken out of the deionized water, dabbed to remove all adhering water droplets and weighed again (w_{wet}). The water uptake was calculated by the following formula and given in % by weight:

$$water uptake = \frac{( {w}_{w e t} - {w}_{dry} )}{{w}_{dry}} * 100 .$$

The results are summarized in table 6.

### 5.2 Elongation at Break

Elasticities of films of the polymer latex (examples C1, C2, C3 and D1 to D6) or of paint films were measured according to DIN 53504. Free films with a dry film thickness of approximately 500 μm were prepared and dried at room temperature for 28 days. Afterwards, each specimen was cut into five S2-bone forms and the actual film thickness measured. The elongation measurement was performed at a fixed stretching speed of 200 mm min⁻¹ at room temperature to obtain the elongation at break in % of elongation compared to initial specimen length and the maximum tensile strength in N mm⁻². Both values are reported as means of the five measurements.

The results are summarized in table 6.

### 5.3 Formulation Recipe

The polymer latexes of examples C5 and D15 to D22 were tested as the following clearcoat formulation. For this, the respective polymer latex was conditioned to a solids content of 45% by weight by addition of water and formulated to a letdown by mixing the latex with deionized water, a film preservative Acticide MKN 9 of Thor GmbH) and a de-aerator (Tego Airex 902W, Evonik). The respective amounts are given in table 5. A paste was prepared by weighing the respective components given in table 5 in a polyethylene beaker and homogenized by means of a dynamic mixer (Speedmixer™ DAC 600.1 FVZ from Hauschild GmbH & Co.) according to the following protocol 1 min at 800 rpm, 1 min at 1000 rpm, 2 min at 1250 rpm and 2.3 min at 1600 rpm. This paste was then divided into different portions and added to the different letdowns, which had been previously prepared and then homogenized with the dynamic mixer according to the following protocol: 1 min at 800 rpm, 1 min at 1000 rpm, 1 min at 1250 rpm and 1.3 min at 1600 rpm.

TABLE 5

| | | |
|---|---|---|
| | Active | |
| Amount [g] | content [wt %] | Product |

Paste

| | | | |
|---|---|---|---|
| DI-Water | 50.0 | 0 | |
| Defoamer | 4.0 | 100 | Tego Foamex 810 |
| Coalescent | 25.0 | 100 | butyldiglykol |
| UV-A absorber | 5.0 | 100 | Tinuvin 1130 |
| Wetting agent | 1.0 | 100 | Surfinol AD 01 |
| In-can preservative | 2.0 | 7.5 | Acticide MBS |
| Neutralizing agent | 2.0 | 25 | Aqueous ammonia |
| Mid shear thickener | 12.0 | 45 | Rheovis PU 1291 |
| High shear thickener | 20.0 | 20 | Rheovis PU 1340 |

Letdown

| | | | |
|---|---|---|---|
| Polymer latex | 715.5 | 45 | |
| DI-Water | 148.5 | 0 | |
| Film preservative | 10.0 | 40 | Acticide MKN 9 |
| De-aerator | 3.0 | 100 | Tego Aerex 902W |

### 5.4 Whitening/Blister Formation

Glass plates were conditioned/cleaned according to ISO 1522: A 100 microns wet film of the coating formulation described in section 5.3 or of the polymer latex (examples C1, C2, C3 and D1 to D6 and D15 to D22) was cast by a film applicator (Erichsen Rakel) on cleaned glass and dried for 1 day at RT (23° C.) and RH (50%). A black background underneath the glass plates provides contrast. A large drop of DI-water (ca. 3 cm in diameter) is placed on the coating and the stopwatch is started. Photo-documentation and schoolnotes (with 0=no water whitening and 5=opaque white) are given after different exposure times. The results are summarized in table 6 and table 7.

In the same experiment blister formation was assessed and ranked by a scale of 0 to 2. 0 means no visible blisters, 1 means a few small blisters 2 means many large blisters. The results are summarized in table 7.

### 5.5 Pendulum Hardness

Pendulum hardness according to König was determined as described in ISO 1522. For this, a 100 microns wet film of the coating formulation described in section 5.3 was cast by a film applicator (Erichsen Rakel) on cleaned glass and dried for the specified time. Then pendulum hardness is measured. The results are summarized in the following table 8.

### 5.6 Blocking Resistance

Blocking resistance was assessed as follows. 6 pine specimen were oriented in parallel, side by side in direct contact. The wood specimen were cut in the same way (tangential cut) and the year rings be oriented in the same direction. In the middle zone of the panels the coating formulation described in section 5.3 was applied by film applicator with a 300 μm wet layer. For the blocking resistance test only the 4 coated middle specimen were used.

The coating was dried for 24 h at 23° C./50% rel. humidity. 2 panels were stacked with the coated area, face to face, over cross. The same was done with the second set of panels. On the contact surface (50×50 mm) a weight of 5 kg (200 g/cm²) was placed the panels were stored at 23° C. in a climatized room (RH=50%). After 24 h, the weight was removed and the wood panels were separated by hand.

The blocking resistance was assessed by the power to separate panels by hand and by the extent of damage according to the following grades:
0=no adhesion (blocking), separates wi/o force needed;
1=trace adhesion;
2=little adhesion;
3=mediocre adhesion;
4=strong adhesion;
5=very strong adhesion, not possible to separate panels by hand.

The results are summarized in table 8.

### 5.7 Durability Against Exposure to UV Radiation

The durability of the coatings against exposure to UV radiation was carried out EN927-6 norm. For this, pine panels were coated with the coating formulation described in section 5.3. Apart from that, the experimental procedure was identical to the EN927-6 norm. Panels were taken out after the specified ˜500 h intervals and gloss measurements were conducted according to DIN 53778 at the 60° angle. Values reported here gloss retention in % with respect to the initial value. The results are summarized in table 9.

TABLE 6

| Polymer | Water | Elongation at | |
|---|---|---|---|
| latex | uptake [wt %] | break [%] | Whitening 1) |
| C1 | 5.6 | 268 | 2 |
| D1 | 4.2 | 344 | 0 |
| D2 | 4.4 | 407 | 0 |
| C2 | 13.5 | 354 | 5 |
| D3 | 8.4 | 413 | 4 |
| D4 | 9.0 | n.d. | 3-4 |
| C3 | 7.8 | 344 | 2 |
| D5 | 6.0 | 407 | 2 |
| D6 | 5.3 | 411 | 1 |

1) Assessed after 240 min, the polymer latex was used as such

TABLE 7

| | Whitening | | | | Blister Formation | | | |
|---|---|---|---|---|---|---|---|---|
| Polymer latex | 0 min | 30 min | 60 min | 180 min | 0 min | 30 min | 60 min | 180 min |
| C5 | 0 | 4 | 5 | 5 | 0 | 2 | 2 | 2 |
| D15 | 0 | 3 | 4 | 5 | 0 | 0 | 0 | 1 |
| D16 | 0 | 2 | 3.25 | 5 | 0 | 0 | 0 | 1 |
| D17 | 0 | 3 | 4 | 5 | 0 | 0 | 0 | 1 |
| D18 | 0 | 3 | 4.5 | 5 | 0 | 0 | 0 | 1 |
| D19 | 0 | 2.5 | 3.75 | 5 | 0 | 0 | 0 | 1 |
| D20 | 0 | 3 | 5 | 5 | 0 | 0 | 0 | 1 |
| D21 | 0 | 3.5 | 5 | 5 | 0 | 0 | 2 | 2 |
| D22 | 0 | 2.5 | 3.5 | 5 | 0 | 0 | 0 | 0 |

TABLE 8

| | | |
|---|---|---|
| Polymer | Pendulum hardness [s⁻¹] | Blocking resistance |

| latex | 1 d | 7 d | 28 d | tack | seal |
|---|---|---|---|---|---|
| C5 | 19.6 | 28.0 | 29.4 | 1 | 0 |
| D15 | 16.8 | 23.8 | 23.8 | 1 | 0 |
| D16 | 16.8 | 25.2 | 26.6 | 2 | 0 |
| D17 | 18.2 | 25.2 | 25.2 | 1 | 0 |
| D18 | 18.2 | 26.6 | 28.0 | 1.5 | 0 |
| D19 | 18.2 | 25.2 | 26.6 | 0.5 | 0 |
| D20 | 18.2 | 25.2 | 26.6 | 1 | 0 |
| D21 | 19.6 | 25.2 | n.d. | 0.25 | 0 |
| D22 | 14.0 | 15.4 | n.d. | 1 | 0 |

TABLE 9

| | |
|---|---|
| Polymer | Gloss retention [%] |

| latex | 504 h | 1008 h | 1512 h | 2016 h |
|---|---|---|---|---|
| C5 | 91 | 90 | 92 | 88 |
| D15 | 71 | 76 | 71 | 74 |
| D16 | 88 | 88 | 85 | 85 |
| D17 | 97 | 98 | 93 | 92 |
| D18 | 91 | 89 | 91 | 91 |
| D19 | 93 | 89 | 84 | 85 |
| D20 | 100 | 100 | 100 | 100 |
| D21 | 97 | 91 | n.d. | n.d. |
| D22 | 91 | 75 | n.d. | n.d. |

### 5.8 Formulation Recipe

The polymer latexes of examples 06 and 023 were tested as the following high-PVC formulation (PVC=77%).

A paste was prepared by weighing the respective components given in table 10 in a polyethylene beaker and homogenized by means of a dynamic mixer (Speedmixer™ DAC 600.1 FVZ from Hauschild GmbH & Co.) for 5 min at 1600 rpm. After ageing for 24 h, the paste was homogenized a second time for 15 min at 1600 rpm. Subsequently, the respective polymer emulsion was added to the paste together with a variable amount of deionized water to account for a total solids content of the paint of 62.8 wt. % and homogenized for 3 min at 200 rpm.

TABLE 10

| | | |
|---|---|---|
| Amount | Active content | |
| [g] | [wt %] | Product |

Paste

| | | | |
|---|---|---|---|
| DI-Water | 270.0 | 0 | |
| Thickener | 4.0 | 100 | Tylose MH 30000 YP4 |
| Neutralizing agent | 2.0 | 10 | sodium hydroxide |
| Pigment dispersant | 5.0 | 10 | Calgon Ng |
| Pigment dispersant | 3.5 | 100 | Dispex AA 4145 |
| Defoamer | 2.0 | 100 | Foamstar ED 2523 |
| Pigment | 80.0 | 100 | Kronos 2044 |
| Filler | 35.0 | 100 | China Clay Speswhite |
| | | | (China Clay B) |
| Filler | 235.0 | 100 | Omyacarb 2 GU |
| Filler | 205.0 | 100 | Omyacarb 5 GU |

Letdown

| | | |
|---|---|---|
| Polymer latex | 145.0 | 50 |
| DI-Water | 13.0 | 0 |

### 5.8 Wet-Scrub Resistance/Opacity

Opacity, respectively hiding power, reflects the ability of a coating to cover a substrate. It can be quantified by spreading rate measurements. These measurements are performed by applying different film thicknesses using a draw-down bar i.e. doctor blade (e.g. 150, 200, 220 and 250 micrometer wet) onto a defined contrast paper, e.g. Leneta foil with black & white areas and subsequent measurement of contrast ratios. Afterwards, the values are interpolated to yield the so called spreading rate, which is the reciprocal of the volume of the paint per area [m²/L] (inverse of the film thickness) which is required to cover a substrate at a given contrast ratio, e.g. 99.5% for a Class I or 98% for a Class II hiding paint according to ISO DIN 13300.

The wet scrub resistance (WSR) of the latex paints prepared was tested by means of the nonwoven pad method in accordance to ISO 11998. WSR is assessed on the basis of the weight loss per unit area caused by abrasion and calculated back to an average thickness loss given in μm.

TABLE 11

| Polymer | | Spreading rate @ | Spreading rate @ |
|---|---|---|---|
| latex | WSR [μm] | 98% [m²/L] | 99.5% [m²/L] |
| C6 | 29 | 6.7 | 4.5 |
| D23 | 22 | 7.4 | 4.9 |

The data in table 11 show that the latex of example D23 provides both better wet scrub resistance and increased spreading rate and hence better opacity to the waterborne coating composition than the latex of comparative example D6.

### 5.9 Semi-Gloss Paints with Polymer Latexes D24 and D7, Respectively

In the semi-gloss paints the following ingredients were used:

| Ingredient/function | Trade Name | Source |
|---|---|---|
| Titanium Dioxide Pigment | Kronos 4311 | Kronos |
| | | Worldwide, Inc |
| Neutralizer containing | AMP-95 | Angus |
| 2-amino-2-methyl-1-propanol | | Chemical |
| | | Company |
| Ammonium salt of a hydrophobic | Tamol 165 A | Dow |
| copolymer as dispersant | | |
| Hyperbranched polymer | Foamstar 2420 | BASF SE |
| defoamer | | |
| Nonvolatile, non-ionic surfactant | Hydropalat | BASF SE |
| as surface levelling and wetting | WE 3320 | |
| agent | | |
| Non-ionic associative thickener | Aquaflow ® | Ashland |
| | NHS-310 | |
| Polymeric pigment | Ropaque Ultra E | Dow |
| Filler produced from nepheline | Minex 10 | Sibelco |
| syenite | | |
| Coalescing agent 2,2,4-trimethyl- | Texanol | Eastman |
| 1,3-pentandiolmonoisobutyrat | | |
| Low odor coalescing agent | Optifilm 400 | Eastman |
| Biocide | Proxel AQ | Lonza |
| Fungicide | Polyphase 663 | Troy Corporation |
| Non-ionic associative thickener | Rheolate CVS 10 | Elementis |
| Non-ionic associative thickener | Acrysol RM 895 | Dow |
| Attapulgite clay | Attagel 50 | BASF SE |

a) Semi-Gloss with Latex D24

315 g Kronos 4311 pigment is mixed with 15 g water. At low stirring speed 1.75 g AMP-95 neutralizer (Angus Chemical Company), 5 g propylene glycol (Univar), 2 g Foamstar 2420 defoamer (BASF), 9 g Tamol 165 A dispersant (Dow) and 3 g Hydropalat WE 3320 wetting agent (BASF) are added. At high stirring speed 1.5 g Attagel 50 (BASF), 25 g Minex 10 (Sibelco) filler and 20 g Aquaflow NHS-310 (Ashland) non-ionic associative thickener are added and mixed for 30 min. Subsequently, 81 g deionized water are added and the mixture is filtered through a 400 μm filter. Then 524.77 g binder from Example 1, 25 g Ropaque Ultra E polymeric pigment (Dow), 2 g Foamstar 2420 defoamer (BASF), 9 g Texanol coalescing agent (Eastman) and 7.7 g Optifilm 400 coalescing agent (Eastman) are added and mixed for 5 min. Then 2 g Proxel AQ biocide (Lonza), 3 g Polyphase 663 fungicide (Troy Corporation) and 3.7 g Rheolate CVS 10 non-ionic associative thickener (Elementis) are added and mixed for 5 min. Finally, 1.7 g Acrysol RM 895 non-ionic associative thickener (Dow) are added and the mixture is stirred for 30 min at medium speed.

b) Semi-Gloss with Latex C7

315 g Kronos 4311 pigment is mixed with 15 g water. At low stirring speed 1.75 g AMP-95 neutralizer (Angus Chemical Company), 5 g propylene glycol (Univar), 2 g Foamstar 2420 defoamer (BASF), 9 g Tamol 165 A dispersant (Dow) and 3 g Hydropalat WE 3320 wetting agent (BASF) are added. At high stirring speed 1.5 g Attagel 50 (BASF), 25 g Minex 10 (Sibelco) filler and 20 g Aquaflow NHS-310 (Ashland) non-ionic associative thickener are added and mixed for 30 min. Subsequently, 104 g deionized water are added and the mixture is filtered through a 400 μm filter. Then 505.05 g binder from Example 2, 25 g Ropaque Ultra E polymeric pigment (Dow), 2 g Foamstar 2420 defoamer (BASF), 9 g Texanol coalescing agent (Eastman) and 7.5 g Optifilm 400 coalescing agent (Eastman) are added and mixed for 5 min. Then 2 g Proxel AQ biocide (Lonza), 3 g Polyphase 663 fungicide (Troy Corporation) and 4.5 g Rheolate CVS 10 non-ionic associative thickener (Elementis) are added and mixed for 5 min. Finally, 2 g Acrysol RM 895 non-ionic associative thickener (Dow) are added and the mixture is stirred for 30 min at medium speed.

### 5.10 Application Properties of Semi-Gloss Paints with Polymer Latexes of Example 24 and Comparative Example C7

Low shear viscosity was measured according to ASTM D562 at 20° C. 7 days after preparation of the semi-gloss paint. The results are summarized in Table 12. High shear viscosity measured according to ASTM D4287 at 20° C. 7 days after preparation of the semi-gloss paint. The results are summarized in Table 12.

Opacity: A coating film was prepared with a 3 mils drawdown bar on a Leneta 3B black and white sealed drawdown card. The film is dried at room temperature for 24 hours. The opacity was determined spectrophotometrically as the ratio of reflected light from the dried coating over the black portions and the white portions of the Leneta card. The opacity indicates the capability of the coating to hide the black surface. The results are summarized in Table 12.

Gloss: A coating film was prepared from the semi-gloss paints with a 3 mils drawdown bar on a Leneta 3B black and white sealed drawdown card. The film was dried at room temperature for 24 hours. Gloss was measured with a gloss meter at angles of 20°, 65° and 80°, respectively. The results are summarized in Table 12.

Scrub resistance was determined according to ASTM D2486 for the semi-gloss paints containing the polymer latex D24 or C7. Scrub cycles were determined before a failure occurs. The results are summarized in Table 12.

In a Quick-UV test according to ASTM D4587, Cycle 4, 1000 h, yellowness index according to ASTM E313 was determined. The results are summarized in Table 12.

TABLE 12

| | Paint with | Paint with |
|---|---|---|
| | Latex D24 | Latex C7 |
| Low shear viscosity, 7 d [KU] | 93.3 | 92.6 |
| High shear viscosity, 7 d [Poise] | 0.66 | 0.60 |
| Opacity | 97.8 | 97.5 |
| Gloss 20° | 14.0 | 11.3 |
| Gloss 65° | 50.4 | 47.5 |
| Gloss 80° | 83.7 | 79.3 |
| Scrub resistance (cycles before failure) | 1069 | 985 |
| Yellowness Index (ASTM E313) | 0.85 | 0.82 |

Intercoat and aluminum adhesion was determined according to ASTM D3359. The results for the semi-gloss paints containing the polymer latex D24 were comparable for those containing the polymer latex C7.

Stain removal was determined according to ASTM D4828: The results for the semi-gloss paints containing the polymer latex D24 were comparable for those containing the polymer latex C7 for pencil, lipstick, crayon, ball pen, red wine, ketchup, coffee, mustard (visual inspection)

Dirt pick-up: The mill glaze on yellow pine wood surface is scrubbed with water and dried overnight. The substrate is divided into sections depending on the number of samples to be tested. Using the appropriate brush, the test paint samples are applied at natural spread rate. The coatings are cured at room temperature for the period of 4 hours and 24 hours, respectively. Then, half of the coated area is covered with 2 inches of dry dirt (Arizona or Carpet soil). The panel is allowed to sit for 15 minutes, then tilted vertically and tapped to release dirt. The dirty area of each sample is lightly brushed (15 strokes).

Slightly less dirt is left on the panel coated with the semi-gloss paint containing polymer latex D24 that on the panel coated with the semi-gloss paint containing polymer latex C7 (visual evaluation).

1-24. (canceled)

25. An aqueous polymer latex of a film-forming copolymer obtained by aqueous emulsion polymerisation of ethylenically unsaturated monomers M, which comprise
20 to 90% by weight, based on the total amount of monomers M, of at least one monomer M1, which is selected from the group consisting of isobutyl acrylate, 2-methylbutyl acrylate and isoamyl acrylate and mixtures thereof,
0 to 55% by weight, based on the total amount of monomers M, of at least one monomer M2, which is selected from the group consisting of ethyl acrylate, n-propyl acrylate, n-butyl acrylate, n-pentyl acrylate, C₆-C₂₀-alkyl esters of acrylic acid and C₅-C₂₀-alkyl esters of methacrylic acid and mixtures thereof;
5 to 50% by weight, based on the total amount of monomers M, of at least one monomer M3, which is selected from the group consisting of tert-butyl acrylate, C₁-C₄-alkyl esters of methacrylic acid, C₅-C₂₀-cycloalkyl esters of acrylic acid, C₅-C₂₀-cycloalkyl esters of methacrylic acid, C₅-C₂₀-cycloalkylmethyl esters of acrylic acid, C₅-C₂₀-cycloalkylmethyl esters of methacrylic acid, where cycloalkyl in the aforementioned monomers is mono-, bi- or tricyclic and where 1 or 2 nonadjacent CH₂ moieties of cycloalkyl may be replaced by oxygen atoms and where cycloalkyl may be unsubstituted or carry 1, 2, 3 or 4 methyl groups, and monovinyl aromatic monomers and mixtures thereof;
0.05 to 4% by weight, based on the total amount of monomers M, of least one monomer M4, which is selected from monoethylenically unsaturated monomers having an acidic group;
where the total amount of monomers M1 and M2 is in the range from 45 to 94.95% by weight, based on the total amount of ethylenically unsaturated monomers M, and where the total amount of monomers M1, M2 and M3 is at least 90% by weight, based on the total amount of ethylenically unsaturated monomers M.

26. The aqueous polymer latex of claim 25, wherein the monomer M1 is isobutyl acrylate.

27. The aqueous polymer latex of claim 25, wherein the monomer M1 is isoamyl acrylate or a mixture comprising isoamyl acrylate and 2-methylbutyl acrylate in an amount of at least 80%, based on the total amount of monomers M1.

28. The aqueous polymer latex of claim 25, wherein at least the carbon atoms of the isobutyl group, the 2-methylbutyl group and the isoamyl group in the monomers M1 are of biological origin.

29. The aqueous polymer latex of claim 25, wherein the monomer M2 is selected from the group consisting of n-butyl acrylate and 2-ethylhexyl acrylate and mixtures thereof.

30. The aqueous polymer latex of claim 25, wherein the monomer M3 comprises methyl methacrylate.

31. The aqueous polymer latex of claim 30, wherein the monomer M3 is selected from the group consisting of methyl methacrylate and combinations of methyl methacrylate and at least one further monomer M3, selected from tert-butyl acrylate, n-butyl methacrylate, cyclohexylmethacrylate, isobornylmethacrylate and styrene.

32. The aqueous polymer latex of claim 30, where the monomers M4 are selected from the group consisting of acrylic acid, methacrylic acid, itaconic acid and combinations thereof.

33. The aqueous polymer latex of claim 30, where the monomers M further comprise at least one monoethylenically unsaturated, non-ionic monomer M5, which has a solubility in deionized water at 20° C. and 1 bar of at least 60 g/L.

34. The aqueous polymer latex of claim 33, where the monomer M5 is selected from the group consisting of non-ionic monoethylenically unsaturated monomers which have a functional group selected from the group consisting of hydroxyalkyl groups, a primary carboxamide group, urea groups and keto groups and combinations thereof.

35. The aqueous polymer latex of claim 33, where the monomers M consist of:
i. 25 to 90% by weight, based on the total amount of monomers M, of isobutyl acrylate as a monomer M1
ii. 0 to 50% by weight, based on the total amount of monomers M, of at least one monomer M2, which is selected from ethyl acrylate, n-propyl acrylate, n-butyl acrylate, C₅-C₂₀-alkyl esters of acrylic acid and C₅-C₂₀-alkyl esters of methacrylic acid;
iii. 10 to 45% by weight, based on the total amount of monomers M, of at least one monomer M3, which is selected from tert-butyl acrylate, C₁-C₄-alkyl esters of methacrylic acid, C₅-C₂₀-cycloalkyl esters of acrylic acid, C₅-C₂₀-cycloalkyl esters of methacrylic acid, C₅-C₂₀-cycloalkylmethyl esters of acrylic acid, C₅-C₂₀-cycloalkylmethyl esters of methacrylic acid, where cycloalkyl in the aforementioned monomers is mono-, bi- or tricyclic and where 1 or 2 nonadjacent CH₂ moieties of cycloalkyl may be replaced by oxygen atoms and where cycloalkyl may be unsubstituted or carry 1, 2, 3 or 4 methyl groups, and monovinyl aromatic monomers;
iv. 0.05 to 4% by weight, based on the total amount of monomers M, of one or more monoethylenically unsaturated monomers M4;
v. 0 to 9.95% by weight, based on the total weight of the monomers M, of one or more non-ionic monomers M5.

36. The aqueous polymer latex of claim 25, where the monomers M comprise:
i. 50 to 70% by weight, based on the total amount of monomers M, of isobutyl acrylate as a monomer M1
iii. 30 to 50% by weight, based on the total amount of monomers M, of methyl methacrylate as monomer M3;
iv. 0.1 to 4% by weight, based on the total amount of monomers M, of a monoethylenically unsaturated carboxylic acid as monomer M4;
v. 0 to 5% by weight, based on the total amount of monomers M, of a monoethylenically unsaturated carboxylic acid amide as monomer M5a
vi. 0 to 10% by weight, based on the total weight of the monomers M, of one or more ethylenically unsaturated non-ionic monomers different from the monomers M1, M3, M4 and M5a.

37. The aqueous polymer latex of claim 25, wherein the particles of the copolymer contained in the polymer latex have a Z-average particle diameter in the range from 30 to 500 nm, in particular in the range from 40 to 350 nm, as determined by quasi-elastic light scattering.

38. The aqueous polymer latex of claim 25, where the polymer particles comprise a polymer phase, which has a glass transition temperature Tg in the range from −25 to +40° C.

39. The aqueous polymer latex of claim 25, where the polymer particles comprise a polymer phase (1), which has a glass transition temperature Tg(1) in the range from −25 to +40° C. and another polymer phase (2), which has a glass transition temperature Tg(2) in the range from +50 to +150° C.

40. The aqueous polymer latex of claim 39, where at least 75% by weight of the monomer M1, based on the total amount of the monomer M1 present in the monomers M, are present in the polymer phase (1).

41. A process for producing an aqueous polymer latex of claim 25, which comprises performing an aqueous emulsion polymerisation of the monomers M.

42. The process of claim 41, where the aqueous emulsion polymerization is performed by a monomer feed process, where at least 90% of the monomers M to be polymerized are fed to a polymerisation vessel as an aqueous emulsion of the monomers.

43. The use of an aqueous polymer latex as defined in claim 25 as a binder in waterborne coating composition.

44. A waterborne coating composition which contains
a) a binder polymer in the form of the aqueous polymer latex as defined in any one of the claims 1 to 16; and
b) at least one further ingredient, which is conventionally used in waterborne coating compositions and which is not a binder.

45. The waterborne coating composition of claim 44, which is a latex paint, in particular a latex paint for architectural coatings, a wood coating or wood staining composition or a latex paint for interior coatings.

46. The waterborne coating composition of claim 44, which contains a titanium dioxide pigment.

47. The waterborne coating composition of claim 46, wherein the weight ratio of the polymer of the polymer latex to the titanium dioxide pigment is in the range of 0.1:5.0 to 5.0:0.1.

48. The use of an aqueous polymer latex as defined in claim 25 for improving the resistance to water or humidity of coatings obtained from waterborne coating composition or for improving the flexibility of a coating obtained from waterborne coating composition.
